(19) United States
(12) Patent Application Publication
(10) Pub. No.: US 2025/0093272 A1
(43) Pub. Date: Mar. 20, 2025

(54) ACTIVATABLE SENSOR PLATFORMS HAVING INDICATORS FOR ACTIVATION VERIFICATION

(71) Applicant: Temptime Corporation, Morris Plains, NJ (US)

(72) Inventors: Eric W. LIBERATO, Pequannock, NJ (US); Mohannad ABDO, Clifton, NJ (US); Brian S. HUFFMAN, Belle Mead, NJ (US)

(73) Assignee: Temptime Corporation, Morris Plains, NJ (US)

(21) Appl. No.: 18/739,732

(22) Filed: Jun. 11, 2024

Related U.S. Application Data
(63) Continuation-in-part of application No. 18/369,498, filed on Sep. 18, 2023.

(51) Int. Cl. G01N 21/78; G01K 11/12

(52) U.S. Cl. CPC G01N 21/78; G01K 11/12

(57) ABSTRACT

Activatable environmental sensing through chemical encapsulation are disclosed herein. An example activatable environmental indicator has a non-activated configuration that is unresponsive to a predetermined environmental stimulus, an activated configuration that is responsive to the predetermined environmental stimulus, and an exposed configuration after responding to the predetermined environmental stimulus. The activatable environmental indicator includes a first visual indicator when the activatable indicator is in the non-activated configuration, a second visual indicator when the activatable indicator is in the activated configuration, and a third visual indicator when the activatable indicator is in the exposed configuration.

### RELATED APPLICATIONS

The present application is a continuation-in-part of U.S. application Ser. No. 18/369,498, filed on Sep. 18, 2023, which is incorporated by reference herein in its entirety.

### BACKGROUND

Perishable products including pharmaceuticals, food products, biologics, which may become unfit or unsafe for use after a certain length of time, or after exposure to various environmental conditions such as high temperature, radiation, UV or light exposure, oxygen exposure, freezing, thawing, or simply the passage of time, or the combination of multiple conditions, such as cumulative excess heat exposure over time. It is desirable to include environmental exposure indicators on such perishable products, or on or in their containers or packaging, in order to detect when products are either unfit for use, or approaching the end of their useful life.

Many indicators are irreversible, or at least have strong hysteresis effects, so that they provide a reliable view of historical exposure to environmental conditions. For example, an indicator might change color when temperature exceeded a threshold and maintain that changed color even after the temperature returned below the threshold, so that someone inspecting the indicator would be informed that the product had been exposed to the excessive temperature. Particularly for sensitive indicators, or indicator materials intended to have a long shelf life, it is desirable that the indicators remain inactive until they are incorporated in a printed label, and/or actually paired with a product that is entering the supply chain or moving into a different phase of the supply chain. Having an indicator which is inactive until a desired time may avoid the need to carefully control the environment in which the indicator is stored prior to activation. In a conventional indicator that does not have an activation, the indicator may need to be stored in highly controlled conditions prior to deployment with a product. For example, a cumulative heat indicator might be stored prior to being paired with a product in a deep freeze; a threshold indicator configured to detect heating above refrigeration temperatures would need to consistently be stored in a refrigerated environment prior to deployment; a sensitive humidity detector would need to be stored in controlled dry conditions. Accordingly, indicators which require an express action to “activate” the indicator and cause it to begin to operate are desirable for many applications. Prior “activatable” environmental indicators have included, for example, indicators with two chemical components, whose reaction controls the indicator process, which are provided separately and then are brought into contact using a physical connection. One example is the Safe-T-Vue® indicator from Zebra Technologies which include an indicator material in a separate reservoirs in a clamshell structure that is folded together to activate the device. A similar structure could be used to separate a two reactants in an indicator relying on a controlled reaction to produce a color change, where the activation brings the reactants into potential contact with other, and to react after a predetermined environmental exposure occurs. Another example is providing reactants in two films that are affixed to each other, e.g., with an adhesive, when the indicator is activated, such as the indicators described in U.S. Pat. No. 6,544,925 to Prusik et al. Other examples include indicators with a removable film barrier that can be withdrawn, e.g., by manually pulling it out, from between the two chemical components.

Thermal printers, which use high temperature print heads to change the color of special printable media, are ubiquitous in the supply chains of many industries. The present disclosure describes activatable indicators that are may be optimized for use in the existing thermal printing ecosystem.

### SUMMARY

Disclosed herein are activatable environmental sensor print media for providing an indication of the historical exposure of the activatable environmental sensor print media to a predetermined environmental stimulus after an activation event.

In an embodiments, the present disclosure provides an activatable environmental indicator that includes a substrate and a plurality of microcapsules supported by the substrate. The activatable environmental indicator has a non-activated configuration that is unresponsive to a predetermined environmental stimulus, an activated configuration that is responsive to the predetermined environmental stimulus, and an exposed configuration after responding to the predetermined environmental stimulus. At least a subset of the plurality of microcapsules release an environmental indicator material in response to an activation event that transitions the activatable environmental indicator from the non-activated configuration to the activated configuration. The environmental indicator material is responsive to the predetermined environmental stimulus after the activation event and transitions the activatable environmental indicator from the activated configuration to the exposed configuration in response to exposure to the predetermined environmental stimulus. The activatable environmental indicator includes a first visual indicator when the activatable indicator is in the non-activated configuration, a second visual indicator when the activatable indicator is in the activated configuration, and a third visual indicator when the activatable indicator is in the exposed configuration.

In another aspect of the present disclosure, which may be used in combination with any other aspect or combination of aspects listed herein, the activatable environmental indicator includes a wick supported by the substrate and an opaque top viewing layer covering the wick and the plurality of microcapsules. The plurality of microcapsules are disposed proximate to a first end of the wick. The opaque top viewing layer includes a plurality of viewing windows disposed over and aligned with the wick such that portions of the wick are viewable via the plurality viewing windows. The environmental indicator material is forced along a portion of the wick in response to the activation event such that the environmental indicator material is visible via a first viewing window of the plurality of viewing windows and is not visible via a second viewing window of the plurality of viewing windows.

In another aspect of the present disclosure, which may be used in combination with any other aspect or combination of aspects listed herein, after the activation event, the environmental indicator material diffuses along the wick in response to exposure to the predetermined environmental stimulus such that the environmental indicator material is visible via the first viewing window and the second viewing window when the environmental indicator is in the exposed configuration.

In another aspect of the present disclosure, which may be used in combination with any other aspect or combination of aspects listed herein, the first visual indicator corresponds to the wick being viewable via the first and second viewing windows and being devoid of the environmental indicator material.

In another aspect of the present disclosure, which may be used in combination with any other aspect or combination of aspects listed herein, the second visual indicator corresponds to the environmental indicator material being viewable via the first viewing window and the wick devoid of the environmental indicator material being viewable via the second viewing window.

In another aspect of the present disclosure, which may be used in combination with any other aspect or combination of aspects listed herein, the third visual indicator corresponds the environmental indicator being viewable via the first and second viewing windows.

In another aspect of the present disclosure, which may be used in combination with any other aspect or combination of aspects listed herein, at least the subset of the plurality of microcapsules or a different subset of the plurality of microcapsules release an activation marker material in response to the activation event.

In another aspect of the present disclosure, which may be used in combination with any other aspect or combination of aspects listed herein, visibility of the activation marker material corresponds to the second visual indicator and visibility of the environmental indicator material corresponds to the third visual indicator.

In another aspect of the present disclosure, which may be used in combination with any other aspect or combination of aspects listed herein, the activation marker material has a first color and the environmental indicator material has a second color.

In another aspect of the present disclosure, which may be used in combination with any other aspect or combination of aspects listed herein, the activatable environmental indicator includes a wick supported by the substrate and an opaque top viewing layer covering the wick and the plurality of microcapsules. The plurality of microcapsules are disposed proximate to a first end of the wick. The opaque top viewing layer includes a viewing window disposed over and aligned with the wick such that a portion of the wick is viewable via the viewing window. In response to the activation event, the activation marker material diffuses along the wick such that the activation marker material is viewable via the viewing window and the environmental indicator material is not visible via the viewing window.

In another aspect of the present disclosure, which may be used in combination with any other aspect or combination of aspects listed herein, after the activation event and in response to exposure to the predetermined environmental stimulus, the environmental indicator material diffuses along the wick such that the environmental indicator is viewable view the viewing window.

In another aspect of the present disclosure, which may be used in combination with any other aspect or combination of aspects listed herein, the viewing window is disposed proximate a second end of the wick and the activation marker material diffuses along the wick towards the second end of the wick, and wherein, after the activation event, absent exposure to the predetermined environmental stimulus, the environmental indicator material remains proximate a first end of the wick.

In another aspect of the present disclosure, which may be used in combination with any other aspect or combination of aspects listed herein, the activatable environmental indicator includes a first wick supported by the substrate, a second wick supported by the substrate, and an opaque top viewing layer covering the first wick, the second wick, the plurality of microcapsules. The subset of the plurality of microcapsules are disposed proximate to the first wick. A different subset of the plurality of microcapsules are disposed proximate to the second wick. The different subset of the plurality of microcapsules contain an activation marker material. The opaque top viewing layer includes a first viewing window and a second viewing window. The first viewing window is disposed over and aligned with a first portion of the first wick such that the first portion of the first wick is viewable via the first viewing window. The second viewing window is disposed over and aligned with a second portion of the second wick such that the second portion of the second wick is viewable via the second viewing window. In response to the activation event, the activation marker material migrates along the second wick such that the activation marker material is viewable via the second viewing window and the environmental indicator material does not migrate along the first wick such that the environment indicator material is not viewable via the first viewing window.

In another aspect of the present disclosure, which may be used in combination with any other aspect or combination of aspects listed herein, after the activation event and in response to exposure to the predetermined environmental stimulus, the environmental indicator material migrates along the first wick such that the environmental indicator is viewable view the first viewing window.

In another aspect of the present disclosure, which may be used in combination with any other aspect or combination of aspects listed herein, the environmental indicator material is configured to respond to exposure to the predetermined environmental stimulus by migrating along the substrate.

In another aspect of the present disclosure, which may be used in combination with any other aspect or combination of aspects listed herein, the environmental indicator material comprises a meltable solid configured to melt into a liquid in response to exposure to the predetermined environmental stimulus.

In another aspect of the present disclosure, which may be used in combination with any other aspect or combination of aspects listed herein, the predetermined environmental stimulus is a predetermined temperature above a threshold for at least a predetermined time period.

In another aspect of the present disclosure, which may be used in combination with any other aspect or combination of aspects listed herein, the environmental indicator material further includes a colorant that migrates together with the liquid.

In another aspect of the present disclosure, which may be used in combination with any other aspect or combination of aspects listed herein, the environmental indicator material comprises a gel configured to, in response to a predetermined temperature above a threshold, change viscosity causing the gel to migrate along the substrate for at least a predetermined distance when remaining at a temperature above the threshold for at least a predetermined time period, and

wherein the environmental indicator material further includes a colorant that migrates together with the gel.

In another aspect of the present disclosure, which may be used in combination with any other aspect or combination of aspects listed herein, the plurality of microcapsules are configured to release the environmental indicator material in response to at least one of an activation heat or an activation pressure provided by a thermal print head.

In another aspect of the present disclosure, which may be used in combination with any other aspect or combination of aspects listed herein, the activation event is an activation heat between 90° C. and 110° C. that is applied to the activatable environmental indicator.

In another aspect of the present disclosure, which may be used in combination with any other aspect or combination of aspects listed herein, the activation event is an activation pressure between 1.5 to 8 pounds per inch that is applied to the activatable environmental indicator.

In another aspect of the present disclosure, which may be used in combination with any other aspect or combination of aspects listed herein, the activation event is an activation heat between 100° C. and 200° C. and an activation pressure between 4 to 15 pounds per inch that is applied to the activatable environmental indicator.

In another aspect of the present disclosure, which may be used in combination with any other aspect or combination of aspects listed herein, the predetermined environmental stimulus is chosen from a list consisting of temperature excursion above a predetermined temperature threshold for at least a predetermined amount of time, temperature excursion below a predetermined temperature for at least a predetermined amount of time, cumulative exposure to temperature above a predetermined threshold for at least a predetermined amount of time, exposure to a particular chemical, oxygen exposure, ammonia exposure, exposure to a particular chemical above a threshold concentration, exposure to a particular chemical above the threshold concentration for at least a predetermined amount of time, exposure to at least a predetermined amount of radiation of a particular type, ultraviolet light exposure, humidity exposure, exposure to a humidity level above a predetermined threshold, and exposure to a humidity level above a predetermined threshold for at least a predetermined amount of time.

In another aspect of the present disclosure, which may be used in combination with any other aspect or combination of aspects listed herein, the environmental indicator material comprises at least one of a polymer having side-chain crystallinity or an alkane wax.

In another aspect of the present disclosure, which may be used in combination with any other aspect or combination of aspects listed herein, the microcapsules are at least one of a gel, a protein, polyurea formaldehyde, polymelamine formaldehyde, a wax material, or emulsions.

In an embodiments, the present disclosure provides a method that includes rendering, by an activatable environmental indicator, a first visual indicator that indicates that the activatable environmental indicator is in a non-activated configuration; and transitioning the activatable environmental indicator from the non-activated configuration to an activated configuration in response to exposing the activatable environmental indicator to an activation event, the activatable environmental indicator including a substrate and a plurality of microcapsules on or embedded in the substrate, at least a subset of the plurality of microcapsules containing an environmental indicator material, the at least a subset of the plurality of microcapsules releasing the environmental indicator material in response to the activation event. The method also includes rendering, by the activatable environmental indicator, a second visual indicator that indicates the activatable environmental indicator is in the activated configuration; transitioning the activatable environmental indicator from the activated configuration to an exposed configuration in response to exposing the activatable environmental indicator to a predetermined environmental stimulus; and rendering, by the activatable environmental indicator, a third visual indicator that indicates the activatable environmental indicator is in the exposed configuration.

In another aspect of the present disclosure, which may be used in combination with any other aspect or combination of aspects listed herein, the activatable environmental indicator includes a wick supported by the substrate, the plurality of microcapsules disposed proximate to a first end of the wick and an opaque top viewing layer covering the wick and the plurality of microcapsules, the opaque top viewing layer includes a plurality of viewing windows disposed over and aligned with the wick such that portions of the wick are viewable via the plurality viewing windows, and the method further includes: disbursing the environmental indicator material along a portion of the wick in response to the activation event such that the environmental indicator material is visible via a first viewing window of the plurality of viewing windows and is not visible via a second viewing window of the plurality of viewing windows.

In another aspect of the present disclosure, which may be used in combination with any other aspect or combination of aspects listed herein, the method further includes: migrating the environmental indicator material along the wick after the activation event in response to exposure to the predetermined environmental stimulus such that the environmental indicator material is visible via the first viewing window and the second viewing window when the environmental indicator is in the exposed configuration.

In another aspect of the present disclosure, which may be used in combination with any other aspect or combination of aspects listed herein, the first visual indicator corresponds to the wick being viewable via the first and second viewing windows and being devoid of the environmental indicator material, the second visual indicator corresponds to the environmental indicator material being viewable via the first viewing window and the wick devoid of the environmental indicator material being viewable via the second viewing window, and the third visual indicator corresponds the environmental indicator being viewable via the first and second viewing windows.

In another aspect of the present disclosure, which may be used in combination with any other aspect or combination of aspects listed herein, the activatable environmental indicator includes a wick supported by the substrate and an opaque top viewing layer covering the wick and the plurality of microcapsules, the opaque top viewing layer includes a viewing window disposed over and aligned with a portion of the wick such that the portion of the wick is viewable via the viewing window, the plurality of microcapsules disposed proximate to the wick, at least the at least a subset of the plurality of microcapsules or a different subset of the plurality of microcapsule containing an activation marker material, and the method further includes: in response to the activation event, migrating the activation marker material along the wick such that the activation marker material is viewable via the viewing window and the environmental indicator material is not viewable via the viewing window.

In another aspect of the present disclosure, which may be used in combination with any other aspect or combination of aspects listed herein, the method includes: migrating the environmental indicator material along the wick such that the environmental indicator is viewable view the viewing window after the activation event and in response to exposure to the predetermined environmental stimulus.

In another aspect of the present disclosure, which may be used in combination with any other aspect or combination of aspects listed herein, the activatable environmental indicator includes a first wick, a second wick, and an opaque top viewing layer, the first wick is supported by the substrate and the at least a subset of the plurality of microcapsules are disposed proximate to the first wick, the second wick is supported by the substrate and a different subset of the plurality of microcapsules is disposed proximate to the second wick, the different subset of the plurality of microcapsules containing an activation marker material, the opaque top viewing layer covering the first wick, the second wick, the subset of the plurality of microcapsules, and the different subset of the plurality of microcapsules, the opaque top viewing layer includes a first viewing window and a second viewing window, the first viewing window disposed over and aligned with a first portion of the first wick such that the first portion of the first wick is viewable via the first viewing window, the second viewing window disposed over and aligned with a second portion of the second wick such that the second portion of the second wick is viewable via the second viewing window, and the method further includes: migrating the activation marker material along the second wick in response to the activation event such that the activation marker material is viewable via the second viewing window and the environmental indicator material does not migrate along the first wick such that the environment indicator material is not viewable via the first viewing window.

In another aspect of the present disclosure, which may be used in combination with any other aspect or combination of aspects listed herein, the method further includes: migrating the environmental indicator material along the first wick such that the environmental indicator is viewable view the first viewing window after the activation event and in response to exposure to the predetermined environmental stimulus.

In another aspect of the present disclosure, which may be used in combination with any other aspect or combination of aspects listed herein, the activation event is at least one of an activation heat between 90° C. and 110° C. that is applied to the activatable environmental indicator, an activation pressure between 1.5 to 8 pounds per inch that is applied to the activatable environmental indicator, or an activation heat between 100° C. and 200° C. and an activation pressure between 4 to 15 pounds per inch that is applied to the activatable environmental indicator.

In another aspect of the present disclosure, which may be used in combination with any other aspect or combination of aspects listed herein, the predetermined environmental stimulus is chosen from a list consisting of temperature excursion above a predetermined temperature threshold for at least a predetermined amount of time, temperature excursion below a predetermined temperature for at least a predetermined amount of time, cumulative exposure to temperature above a predetermined threshold for at least a predetermined amount of time, exposure to a particular chemical, oxygen exposure, ammonia exposure, exposure to a particular chemical above a threshold concentration, exposure to a particular chemical above the threshold concentration for at least a predetermined amount of time, exposure to at least a predetermined amount of radiation of a particular type, ultraviolet light exposure, humidity exposure, exposure to a humidity level above a predetermined threshold, and exposure to a humidity level above a predetermined threshold for at least a predetermined amount of time.

In an embodiment, the present disclosure includes an activatable environmental indicator (e.g., an activatable environmental sensor print medium) comprising a substrate, an environmental indicator material configured to respond to a predetermined environmental stimulus, and a plurality of microcapsules on or embedded in the substrate containing the environmental indicator material. The microcapsules are configured to respond to at least one of an activation heat or an activation pressure by allowing the environmental indicator material to be released from the microcapsules. The environmental indicator material, after being released from the microcapsules, is configured to respond to exposure to the predetermined environmental stimulus by causing a detectable response.

In another aspect of the present disclosure, which may be used in combination with any other aspect or combination of aspects listed herein, the detectable response is selected from a group consisting of a color state change, a change in transparency, a change in hue, a change in an electrical property, a change in conductivity, a change in capacitance, movement of the environmental indicator material along the substrate, and combinations thereof.

In another aspect of the present disclosure, which may be used in combination with any other aspect or combination of aspects listed herein, the environmental indicator material is configured to respond to exposure to the predetermined environmental stimulus by migrating along the substrate.

In another aspect of the present disclosure, which may be used in combination with any other aspect or combination of aspects listed herein, the environmental indicator material further comprises a meltable solid configured to melt in response to a predetermined temperature above a threshold, forming a liquid that migrates along the substrate for at least a predetermined distance when remaining at a temperature above the threshold for at least a predetermined time period.

In another aspect of the present disclosure, which may be used in combination with any other aspect or combination of aspects listed herein, the environmental indicator material further includes a colorant that migrates together with the liquid.

In another aspect of the present disclosure, which may be used in combination with any other aspect or combination of aspects listed herein, the activatable environmental indicator (e.g., activable environmental sensor print medium) further comprises a wick on or in the substrate, and is positioned to allow the released environmental indicator material and the colorant to migrate along the wick.

In another aspect of the present disclosure, which may be used in combination with any other aspect or combination of aspects listed herein, the environmental indicator material comprises a gel configured to, in response to a predetermined temperature above a threshold, change viscosity causing the gel to migrate along the substrate for at least a predetermined distance when remaining at a temperature above the threshold for at least a predetermined time period.

In another aspect of the present disclosure, which may be used in combination with any other aspect or combination of aspects listed herein, the environmental indicator material further includes a colorant that migrates together with the gel.

In another aspect of the present disclosure, which may be used in combination with any other aspect or combination of aspects listed herein, the activatable environmental indicator (e.g., environmental activatable sensor print medium) further comprises a wick on or in the substrate, and is positioned to allow the released environmental indicator material and the colorant to migrate along the wick.

In another aspect of the present disclosure, which may be used in combination with any other aspect or combination of aspects listed herein, the microcapsules are configured to respond to the activation heat and the activation pressure provided by a direct thermal print head.

In another aspect of the present disclosure, which may be used in combination with any other aspect or combination of aspects listed herein, the activation heat is between 90° C. and 110° C.

In another aspect of the present disclosure, which may be used in combination with any other aspect or combination of aspects listed herein, the activation pressure is between 1.5 to 8 pounds per inch.

In another aspect of the present disclosure, which may be used in combination with any other aspect or combination of aspects listed herein, the activation heat is between 100° C. and 200° C. and the activation pressure is between 4 to 15 pounds per inch.

In another aspect of the present disclosure, which may be used in combination with any other aspect or combination of aspects listed herein, the predetermined environmental stimulus is chosen from a list consisting of temperature excursion above a predetermined temperature threshold for at least a predetermined amount of time, temperature excursion below a predetermined temperature for at least a predetermined amount of time, cumulative exposure to temperature above a predetermined threshold for at least a predetermined amount of time, exposure to a particular chemical, oxygen exposure, ammonia exposure, exposure to a particular chemical above a threshold concentration, exposure to a particular chemical above the threshold concentration for at least a predetermined amount of time, exposure to at least a predetermined amount of radiation of a particular type, ultraviolet light exposure, humidity exposure, exposure to a humidity level above a predetermined threshold, and exposure to a humidity level above a predetermined threshold for at least a predetermined amount of time.

In another aspect of the present disclosure, which may be used in combination with any other aspect or combination of aspects listed herein, the environmental indicator material comprises a polymer having side-chain crystallinity.

In another aspect of the present disclosure, which may be used in combination with any other aspect or combination of aspects listed herein, the environmental indicator material comprises an alkane wax.

In another aspect of the present disclosure, which may be used in combination with any other aspect or combination of aspects listed herein, the microcapsules are a gel.

In another aspect of the present disclosure, which may be used in combination with any other aspect or combination of aspects listed herein, the microcapsules are a protein.

In another aspect of the present disclosure, which may be used in combination with any other aspect or combination of aspects listed herein, the microcapsules are polyurea formaldehyde.

In another aspect of the present disclosure, which may be used in combination with any other aspect or combination of aspects listed herein, the microcapsules are a wax material.

In another aspect of the present disclosure, which may be used in combination with any other aspect or combination of aspects listed herein, the microcapsules are emulsions.

In another aspect of the present disclosure, which may be used in combination with any other aspect or combination of aspects listed herein, the microcapsules have an outer diameter length between 20 to 250 μm.

In another aspect of the present disclosure, which may be used in combination with any other aspect or combination of aspects listed herein, the microcapsules respond by fracturing, melting, breaking, dissolving, or becoming porous.

In another aspect of the present disclosure, which may be used in combination with any other aspect or combination of aspects listed herein, the microcapsules have at least a first wall and a second wall encapsulating the environmental indicator material. The first wall is configured to respond to the predetermined environmental stimulus and the second wall is configured to respond to a second predetermined environmental stimulus.

In another aspect of the present disclosure, which may be used in combination with any other aspect or combination of aspects listed herein, the predetermined environmental stimulus is chosen from a list consisting of temperature excursion above a predetermined temperature threshold for at least a predetermined amount of time, temperature excursion below a predetermined temperature for at least a predetermined amount of time, cumulative exposure to temperature above a predetermined threshold for at least a predetermined amount of time, exposure to a particular chemical, oxygen exposure, ammonia exposure, exposure to a particular chemical above a threshold concentration, exposure to a particular chemical above the threshold concentration for at least a predetermined amount of time, exposure to at least a predetermined amount of radiation of a particular type, ultraviolet light exposure, humidity exposure, exposure to a humidity level above a predetermined threshold, and exposure to a humidity level above a predetermined threshold for at least a predetermined amount of time.

In another aspect of the present disclosure, which may be used in combination with any other aspect or combination of aspects listed herein, the second predetermined environmental stimulus is chosen from a list consisting of temperature excursion above a predetermined temperature threshold for at least a predetermined amount of time, temperature excursion below a predetermined temperature for at least a predetermined amount of time, cumulative exposure to temperature above a predetermined threshold for at least a predetermined amount of time, exposure to a particular chemical, oxygen exposure, ammonia exposure, exposure to a particular chemical above a threshold concentration, exposure to a particular chemical above the threshold concentration for at least a predetermined amount of time, exposure to at least a predetermined amount of radiation of a particular type, ultraviolet light exposure, humidity exposure, exposure to a humidity level above a predetermined threshold, and exposure to a humidity level above a predetermined threshold for at least a predetermined amount of time.

In another aspect of the present disclosure, which may be used in combination with any other aspect or combination of aspects listed herein, an activatable environmental indicator (e.g., environmental activatable sensor print medium) comprising a substrate, an environmental indicator material configured to respond to a predetermined environmental stimulus, and a plurality of microcapsules on or embedded in the substrate containing the environmental indicator material. The microcapsules are configured to respond to at least one of an activation heat and an activation pressure by allowing the environmental indicator material to be released from the microcapsules. The environmental indicator material, after being released from the microcapsules, is configured to migrate along the substrate in response to exposure to the predetermined environmental stimulus by causing a detectable response.

In another aspect of the present disclosure, which may be used in combination with any other aspect or combination of aspects listed herein, the activatable environmental indicator (e.g., activatable environmental sensor print medium) further comprises a wick on or in the substrate and is positioned to allow the released environmental indicator material to migrate along the wick.

In another aspect of the present disclosure, which may be used in combination with any other aspect or combination of aspects listed herein, the wick is made from a material selected from the group consisting of filter paper; pulverized filter paper; fine silica gel; porous films containing polytetrafluoroethylene resin or silica gel; TESLIN microporous synthetic sheet; non-woven, spun bonded materials including non-woven, spun-bonded high-density-polyethylene, polypropylene and polyester, and non-woven, spun-bonded blends of any two or more such polymers.

In another aspect of the present disclosure, which may be used in combination with any other aspect or combination of aspects listed herein, the detectable response is selected from a group consisting of a color state change, a change in transparency, a change in hue, a change in an electrical property, a change in conductivity, a change in capacitance, movement of the environmental indicator material along the substrate, and combinations thereof.

In another aspect of the present disclosure, which may be used in combination with any other aspect or combination of aspects listed herein, the environmental indicator material is configured to respond to exposure to the predetermined environmental stimulus by migrating along the substrate.

In another aspect of the present disclosure, which may be used in combination with any other aspect or combination of aspects listed herein, the environmental indicator material further comprises a meltable solid configured to melt in response to a predetermined temperature above a threshold, forming a liquid that migrates along the substrate for at least a predetermined distance when remaining at a temperature above the threshold for at least a predetermined time period.

In another aspect of the present disclosure, which may be used in combination with any other aspect or combination of aspects listed herein, the environmental indicator material further includes a colorant that migrates together with the liquid, and the detectable response is a change in color in a location to which the environmental indicator material has migrated.

In another aspect of the present disclosure, which may be used in combination with any other aspect or combination of aspects listed herein, the environmental indicator material comprises a gel configured to, in response to a predetermined temperature above a threshold, change viscosity causing the gel to migrate along the substrate for at least a predetermined distance when remaining at a temperature above the threshold for at least a predetermined time period.

In another aspect of the present disclosure, which may be used in combination with any other aspect or combination of aspects listed herein, the environmental indicator material further includes a colorant that migrates together with the gel.

In another aspect of the present disclosure, which may be used in combination with any other aspect or combination of aspects listed herein, the microcapsules are configured to respond to the activation heat and the activation pressure provided by a direct thermal print head.

In another aspect of the present disclosure, which may be used in combination with any other aspect or combination of aspects listed herein, the activation heat is between 90° C. and 110° C.

In another aspect of the present disclosure, which may be used in combination with any other aspect or combination of aspects listed herein, the activation pressure is 1.5 to 8 pounds per inch.

In another aspect of the present disclosure, which may be used in combination with any other aspect or combination of aspects listed herein, the activation heat is between 100° C. and 200° C. and the activation pressure is between 4 to 15 pounds per inch.

In another aspect of the present disclosure, which may be used in combination with any other aspect or combination of aspects listed herein, the predetermined environmental stimulus is chosen from a list consisting of temperature excursion above a predetermined temperature threshold for at least a predetermined amount of time, temperature excursion below a predetermined temperature for at least a predetermined amount of time, cumulative exposure to temperature above a predetermined threshold for at least a predetermined amount of time, exposure to a particular chemical, oxygen exposure, ammonia exposure, exposure to a particular chemical above a threshold concentration, exposure to a particular chemical above the threshold concentration for at least a predetermined amount of time, exposure to at least a predetermined amount of radiation of a particular type, ultraviolet light exposure, humidity exposure, exposure to a humidity level above a predetermined threshold, and exposure to a humidity level above a predetermined threshold for at least a predetermined amount of time.

In another aspect of the present disclosure, which may be used in combination with any other aspect or combination of aspects listed herein, the environmental indicator material comprises a polymer having side-chain crystallinity.

In another aspect of the present disclosure, which may be used in combination with any other aspect or combination of aspects listed herein, the environmental indicator material comprises an alkane wax.

In another aspect of the present disclosure, which may be used in combination with any other aspect or combination of aspects listed herein, the microcapsules are a gel.

In another aspect of the present disclosure, which may be used in combination with any other aspect or combination of aspects listed herein, the microcapsules are a protein.

In another aspect of the present disclosure, which may be used in combination with any other aspect or combination of aspects listed herein, the microcapsules are polyurea formaldehyde.

In another aspect of the present disclosure, which may be used in combination with any other aspect or combination of aspects listed herein, the microcapsules are polymelamine formaldehyde.

In another aspect of the present disclosure, which may be used in combination with any other aspect or combination of aspects listed herein, the microcapsules are a wax material.

In another aspect of the present disclosure, which may be used in combination with any other aspect or combination of aspects listed herein, the microcapsules are emulsions.

In another aspect of the present disclosure, which may be used in combination with any other aspect or combination of aspects listed herein, the microcapsules have an outer diameter length between 20 to 250 μm.

In another aspect of the present disclosure, which may be used in combination with any other aspect or combination of aspects listed herein, the microcapsules respond by fracturing, melting, breaking, dissolving, or becoming porous.

In another aspect of the present disclosure, which may be used in combination with any other aspect or combination of aspects listed herein, the microcapsules have at least a first wall and a second wall encapsulating the environmental indicator material. The first wall is configured to respond to the predetermined environmental stimulus and the second wall is configured to respond to a second predetermined environmental stimulus.

In another aspect of the present disclosure, which may be used in combination with any other aspect or combination of aspects listed herein, the predetermined environmental stimulus is chosen from a list consisting of temperature excursion above a predetermined temperature threshold for at least a predetermined amount of time, temperature excursion below a predetermined temperature for at least a predetermined amount of time, cumulative exposure to temperature above a predetermined threshold for at least a predetermined amount of time, exposure to a particular chemical, oxygen exposure, ammonia exposure, exposure to a particular chemical above a threshold concentration, exposure to a particular chemical above the threshold concentration for at least a predetermined amount of time, exposure to at least a predetermined amount of radiation of a particular type, ultraviolet light exposure, humidity exposure, exposure to a humidity level above a predetermined threshold, and exposure to a humidity level above a predetermined threshold for at least a predetermined amount of time.

In another aspect of the present disclosure, which may be used in combination with any other aspect or combination of aspects listed herein, the second predetermined environmental stimulus is chosen from a list consisting of temperature excursion above a predetermined temperature threshold for at least a predetermined amount of time, temperature excursion below a predetermined temperature for at least a predetermined amount of time, cumulative exposure to temperature above a predetermined threshold for at least a predetermined amount of time, exposure to a particular chemical, oxygen exposure, ammonia exposure, exposure to a particular chemical above a threshold concentration, exposure to a particular chemical above the threshold concentration for at least a predetermined amount of time, exposure to at least a predetermined amount of radiation of a particular type, ultraviolet light exposure, humidity exposure, exposure to a humidity level above a predetermined threshold, and exposure to a humidity level above a predetermined threshold for at least a predetermined amount of time.

In another aspect of the present disclosure, which may be used in combination with any other aspect or combination of aspects listed herein, a method of activating an environmental indicator (e.g., an environmental sensor print medium) comprises a first step of receiving a substrate that has a plurality of microcapsules on or embedded in the substrate and an environmental indicator material contained within the microcapsules. A second step includes applying at least one of an activation heat and an activation pressure by allowing the environmental indicator material to be released from the microcapsules. The microcapsules are configured to respond to at least one of an activation heat and an activation pressure by allowing the environmental indicator material to be released from the microcapsules. The environmental indicator material, after being released from the microcapsules, is configured to respond to exposure to a predetermined environmental stimulus by causing a detectable response.

In another aspect of the present disclosure, which may be used in combination with any other aspect or combination of aspects listed herein, the substrate is a label print stock.

In another aspect of the present disclosure, which may be used in combination with any other aspect or combination of aspects listed herein, the information is printed using a direct thermal printer and the activation heat and pressure is applied using the same thermal printer that is used to print information on the label print stock.

In another aspect of the present disclosure, which may be used in combination with any other aspect or combination of aspects listed herein, the method further comprises a step of applying the printed label to a host product or applying the label print stock to a host product prior to printing the information.

In another aspect of the present disclosure, which may be used in combination with any other aspect or combination of aspects listed herein, the microcapsules have at least a first wall and a second wall encapsulating the environmental indicator material. The first wall is configured to respond to the predetermined environmental stimulus and the second wall is configured to respond to a second predetermined environmental stimulus.

In another aspect of the present disclosure, which may be used in combination with any other aspect or combination of aspects listed herein, the predetermined environmental stimulus is chosen from a list consisting of temperature excursion above a predetermined temperature threshold for at least a predetermined amount of time, temperature excursion below a predetermined temperature for at least a predetermined amount of time, cumulative exposure to temperature above a predetermined threshold for at least a predetermined amount of time, exposure to a particular chemical, oxygen exposure, ammonia exposure, exposure to a particular chemical above a threshold concentration, exposure to a particular chemical above the threshold concentration for at least a predetermined amount of time, exposure to at least a predetermined amount of radiation of a particular type, ultraviolet light exposure, humidity exposure, exposure to a humidity level above a predetermined threshold, and exposure to a humidity level above a predetermined threshold for at least a predetermined amount of time.

In another aspect of the present disclosure, which may be used in combination with any other aspect or combination of aspects listed herein, the second predetermined environmental stimulus is chosen from a list consisting of temperature excursion above a predetermined temperature threshold for at least a predetermined amount of time, temperature excursion below a predetermined temperature for at least a predetermined amount of time, cumulative exposure to temperature above a predetermined threshold for at least a predetermined amount of time, exposure to a particular chemical, oxygen exposure, ammonia exposure, exposure to a particular chemical above a threshold concentration, exposure to a particular chemical above the threshold concentration for at least a predetermined amount of time, exposure to at least a predetermined amount of radiation of a particular type, ultraviolet light exposure, humidity exposure, exposure to a humidity level above a predetermined threshold, and exposure to a humidity level above a predetermined threshold for at least a predetermined amount of time.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 illustrates a perspective view of the layers of an activatable environmental indicator (e.g., an activatable environmental sensor print medium), according to an example of the present disclosure.

FIG. 2 illustrates a cross-sectional view of a microcapsule containing an environmental indicator material, according to an example of the present disclosure.

FIG. 3 illustrates a micrograph view of microcapsules containing an environmental indicator material, according to an example of the present disclosure.

FIG. 4 illustrates a micrograph view of microcapsules containing an environmental indicator material after the occurrence of an activation event, according to an example of the present disclosure.

FIG. 5 illustrates a micrograph view of microcapsules containing an environmental indicator material after the occurrence of an activation event, according to an example of the present disclosure.

FIG. 6 illustrates a cross-sectional view of a microcapsule having two microcapsule shells and containing an environmental indicator material, according to an example of the present disclosure.

FIG. 7 illustrates an activatable environmental indicator (e.g., an activatable environmental sensor print medium) in a non-activated configuration, according to an example of the present disclosure.

FIG. 8A illustrates an activatable environmental indicator (e.g., an activatable environmental sensor print medium) in an activated configuration after the microcapsules have ruptured, but prior to the environmental sensor being exposed to the corresponding predetermined environmental stimulus, according to an example of the present disclosure.

FIG. 8B illustrates an activatable environmental indicator (e.g., an activatable environmental sensor print medium) in an activated configuration after the microcapsules have ruptured, but prior to the environmental sensor being exposed to the corresponding predetermined environmental stimulus with an activation indicator material displaying the activation, according to an example of the present disclosure.

FIG. 9 illustrates an activatable environmental indicator (e.g., an activatable environmental sensor print medium) in an activated configuration after full exposure to the predetermined environmental stimulus, according to an example of the present disclosure.

FIG. 10 illustrates an activatable environmental indicator (e.g., an activatable environmental sensor print medium) in a non-activated configuration with a top viewing layer having a viewing window, according to an example of the present disclosure.

FIG. 11A illustrates an activatable environmental indicator (e.g., an activatable environmental sensor print medium) in an activated configuration after the microcapsules have ruptured, but prior to the environmental sensor being exposed to the corresponding predetermined environmental stimulus with an activation indicator material displaying the activation, according to an example of the present disclosure.

FIG. 11B illustrates an activatable environmental indicator (e.g., an activatable environmental sensor print medium) in an activated configuration with the environmental indicator material having been exposed to the predetermined environmental stimulus, according to an example of the present disclosure.

FIG. 12 illustrates an activatable environmental indicator (e.g., an activatable environmental sensor print medium) in various stages before and after exposure to an activation event.

FIGS. 13A-B illustrate an example activatable indicator in a non-activated configuration with a visual indicator corresponding to the non-activated configuration, according to an example of the present disclosure.

FIGS. 14A-B illustrate the example activatable indicator of FIGS. 13A-B in an activated configuration with a visual indicator corresponding to the activated configuration, according to an example of the present disclosure.

FIGS. 15A-B illustrate the example activatable indicator of FIGS. 13A-B in an exposed configuration with a visual indicator corresponding to the exposed configuration, according to an example of the present disclosure.

FIGS. 16A-B illustrate another example activatable indicator in a non-activated configuration with a visual indicator corresponding to the non-activated configuration, according to an example of the present disclosure.

FIGS. 17A-B illustrate the example activatable indicator of FIGS. 16A-B in an activated configuration with a visual indicator corresponding to the activated configuration, according to an example of the present disclosure.

FIGS. 18A-B illustrate the example activatable indicator of FIGS. 16A-B in an exposed configuration with a visual indicator corresponding to the exposed configuration, according to an example of the present disclosure.

FIG. 19A illustrates another example activatable indicator in a non-activated configuration with a visual indicator corresponding to the non-activated configuration, according to an example of the present disclosure.

FIG. 19B illustrates the example activatable indicator of FIG. 19A in an activated configuration with a visual indicator corresponding to the activated configuration, according to an example of the present disclosure.

FIG. 19C illustrates the example activatable indicator of FIG. 19A in an exposed configuration with a visual indicator corresponding to the exposed configuration, according to an example of the present disclosure.

FIG. 20A illustrates another example activatable indicator in a non-activated configuration with a visual indicator corresponding to the non-activated configuration, according to an example of the present disclosure.

FIG. 20B illustrates the example activatable indicator of FIG. 20A in an activated configuration with a visual indicator corresponding to the activated configuration, according to an example of the present disclosure.

FIG. 20C illustrates the example activatable indicator of FIG. 20A in an exposed configuration with a visual indicator corresponding to the exposed configuration, according to an example of the present disclosure.

FIG. 21A illustrates a first method of activating an activatable environmental indicator (e.g., an activatable environmental sensor print medium), according to an example of the present disclosure.

FIG. 21B illustrates a second method of activating an activatable environmental indicator (e.g., an activatable environmental sensor print medium), according to an example of the present disclosure.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

The present disclosure describes environmental indicator materials contained within activatable microcapsules that may be activated by heat and/or pressure, e.g., using a thermal print head of a conventional or modified thermal printer, where a visual indication of successful activation (placing the indicator material in the activation configuration) can be generated in response to activation (an activation event) so that it can be readily observed when the indicator is placed in the activated configuration, e.g., by a user or imaging system. These indicators may be provided in modified versions of thermal print media stock, so that, in some cases, the same thermal printer may be used both to print on the media and to activate, or selectively activate the environmental indicators. The activatable environmental indicators may be used for other types of activatable environmental exposure indicators, and particularly exposure indicators, such as radiation, oxygen, light, ultraviolet (UV), humidity, or simply the passage of time, as described in greater detail below.

Additionally, techniques for printing activatable environmental exposure indicators, such as temperature excursion or time-temperature exposure indicators, using a thermal printer stock are disclosed. Prior applications involving thermal printing have not addressed using an activatable environmental indicator material contained in microcapsules. While such prior indicators may be configured to be thermally printed, the indicators are provided on the thermal print stock, but are not activated by the thermal printer-they instead are active approximately from the instant the indicator materials are provided on the print stock. Either the thermal printer is configured to avoid printing on the indicator material, or the indicator material is insulated or otherwise configured so it is not materially affected by the thermal printing process, or in some cases for example in Zebra Technologies U.S. patent application Ser. No. 17/877,287, the thermal printer is intentionally used to print some of the environmental indicator materials, so they are placed into the state showing they have been exposed to a temperature excursion. Also, in those prior approaches, existing thermal printing processes often print static information that is not intended to be sensitive to environmental factors such as temperature, time, time-temperature product, freezing, nuclear radiation, toxic chemicals, or the like.

These activatable environmental indicators have been generally limited as environmental sensing of materials below ambient temperature requires materials that are manufactured and handled (e.g., shipped and stored) in environments below the response temperature. By facilitating activation of the indicators at the end point of application, storage, shipping and manufacturing costs for the indicators may decrease and the reliance on activation methods can increase.

A need exists for an activatable medium that is easily employed by an end-user and provides efficient, on-demand activation during the printing of labels containing environmental exposure indicators of various types, where successful or unsuccessful activation on the environmental exposure indicators can be determined based on a visual indication, e.g., with the naked eye and/or with the assistance of an imaging system and/or an illumination source after an activation event and before the activated environmental indicator material is exposed to a predetermined environmental stimulus.

The present disclosure describes environmental exposure indicators (including indicators that simply show the passage of time) which may be provided as part of a printable medium, such as printable webs, paper, or other print stocks. The indicators may be provided initially in an inactive state, so they tend not respond to the environmental stimulus of interest. This may be accomplished, e.g., by having an indicator which indicates exposure to the environmental stimulus by the reaction of two or more components that are physically separated prior to activation by a barrier. In this manner, the environmentally sensitive indicators may be provided as part of a special print stock that may be printed and activated during the printing process. Another approach to this is to encapsulate the environmental indicator materials (e.g., in microcapsules) to prevent the environmental indicator materials and/or environmental sensors including the environmental indicator materials from reacting to the environment when the response condition is satisfied and to selectively activate the indicator materials and/or the environmental sensor including the environmental indicator material by rupturing the encapsulation to release the indicator materials as described herein and in concurrently filed related applications: U.S. patent application Ser. No. 18/369,520, titled “MEDIA PROCESSING DEVICE AND COMPONENTS FOR ACTIVATABLE MEDIA PLATFORMS” (Attorney Docket No. 0820887.00358); U.S. patent application Ser. No. 18/369,536, titled “MEDIA CONSTRUCTION TO FACILITATE USE OF ACTIVATABLE PLATFORM” (Attorney Docket No. 0820887.00359); U.S. patent application Ser. No. 18/369,506, titled “USE OF ENCAPSULATED POLAR PROTIC CHEMISTRIES FOR RFID TEMPERATURE MONITORING” (Attorney Docket No. 0820887.00355); and U.S. patent application Ser. No. 18/369,548, titled “RIBBON FOR USE IN PRODUCING PRINTER ACTIVATABLE INDICATORS” (Attorney Docket No. 0820887.00356).

As used herein, the term “activation event” is a treatment, e.g., the exposure to certain amount of heat and/or pressure that causes the activation material to cease preventing the environmental exposure indicator from operating. The activation event may include the application of an activation heat, an activation pressure, or a combination thereof. The use of applied heat may reduce the amount of pressure required for activation as compared to activation without applied heat, or vice versa.

As used herein, the term “non-activated configuration” refers to a configuration in which the microcapsules fully encapsulate the environmental indicator material inhibiting the operation of the environmental indicator material so that the environmental indicator material will not respond, or will respond only in a materially reduced manner, to the relevant predetermined environmental stimulus. The “activated configuration” refers to a configuration in which the environmental indicator material is not fully contained within the microcapsules such that the environmental indicator material will respond in its intended fashion to the relevant predetermined environmental stimulus, e.g., depending on the type of environmental indicator, either immediately upon exposure beyond a threshold, or over time, or over a rate dependent on amount of exposure. The “exposed configuration” refers to a configuration in which the environment indicator material has responded to an exposure to the predetermined environmental stimulus.

As used herein, the term “activation device” is a device configured to selectively cause the microcapsules to transition from its non-activated configuration to its activated configuration.

As used herein, the term “print head” refers to a component of an activation device that transfers heat and/or pressure to an activatable print medium in response to an instruction from the activation device.

As used herein, the term “predetermined environmental stimulus” is an environmental condition in which the environmental indicator material is configured to respond. The predetermined environmental stimulus may include, but is not limited to, temperature excursion above a predetermined temperature threshold, temperature excursion above a predetermined temperature threshold for at least a predetermined amount of time, temperature excursion below a predetermined temperature for at least a predetermined amount of time, cumulative exposure to temperature above a predetermined threshold for at least a predetermined amount of time, exposure to a particular chemical, oxygen exposure, ammonia exposure, exposure to a particular chemical above a threshold concentration, exposure to a particular chemical above the threshold concentration for at least a predetermined amount of time, exposure to at least a predetermined amount of radiation of a particular type, ultraviolet light exposure, humidity exposure, exposure to a humidity level above a predetermined threshold, and exposure to a humidity level above a predetermined threshold for at least a predetermined amount of time.

As used herein, the term “environmental indicator material” refers to a material that exhibits a detectable response after being released from the microcapsules when it is exposed to a predetermined environmental stimulus. The detectable response may include a color state change, a change in transparency, a change in hue, a change in an electrical property, a change in conductivity, a change in capacitance, movement of the environmental indicator material along a substrate, or combinations thereof. In some embodiments, the environmental indicator material is configured to undergo a continuous chemical or physical state change between an “initial state” and an “end state”. In some embodiments, the change of state may be a change in a property, e.g., an optical property, such as a reflectance value, saturation value, color value, color density value, optical density value or color hue value of the “reactive component” or an electrical property. Specifically, the state change (e.g., optical property change) may provide exposure information indicating an exposure to an environmental stimulus since the environmental exposure indicator was in the “activated configuration.”

### Activation Using Thermal Printer or Other Device

A conventional thermal printing technology for printing data forms or images, such as barcode symbols and/or text, is direct thermal printing. A direct thermal printer does not use a ribbon, but instead the printable media itself is the thermal media. The direct thermal media is manufactured or coated with a thermochromic material that changes color when exposed to sufficient heat, such as a leuco dye, which switches from a first chemical form that is colorless to a second chemical form that is black or colored. The web of direct thermal media is pressed against and moved past the thermal print head. The thermal print head receives data of a rendered bitmap and heats specific heating elements within the row of addressable heaters according to the data.

To print labels or other documents, thermal printers may use a thermal print head comprising a row of addressable heating elements to heat a thermal media. The elements are small compared to the image to be printed; e.g., 8, 12, or 24 elements per mm are typical, and other resolutions, are commercially available. This differs from thermal inkjet printers which use addressable heaters to heat an ink or wax that is dropped or ejected to a document or other printable media.

Heat from the heated elements causes the thermochromic material on the printable media to transition from colorless to black or from colorless to colored. Print head heating elements which are not heated do not cause a color transition. In some direct thermal media, a first zone of the printable media includes thermochromic material that transitions from colorless to a first color while a second zone of the printable media includes thermochromic material that transitions from colorless to a second different color. Some direct thermal media comprise a multi-layer arrangement including a first layer of a first color and a second non-transparent layer of a second color. For the multi-layer arrangements, heat from the heated print head elements cause the second layer to transition to a transparent state revealing the color of the first layer.

Conventional print media may be used as a carrier to hold the environmental indicator materials which then may be activated using an activation device, e.g., a thermal printer. The conventional print media backing may be placed either underneath the transparent upper layers or on the bottom most portion of the environmental indicator beneath the activatable portion, or applied as an additional layer over top of the print media, or incorporated as an element of an existing layer by modifying the process for manufacturing the conventional print media. Additionally, certain layers of the environmental indicators may also include conventional printer media elements as a supportive substrate.

In addition to the media being printable with a conventional thermal printing process, the activatable environmental indicator (e.g., an activatable environmental sensor print medium) is activatable as a result of exposure to temperature and/or pressure changes, e.g., from heat and pressure applied using the conventional thermal print head. The microcapsules on or embedded in the print media or other substrate may be configured such that the activatable environmental sensor print media is sensitive to high temperature the application of pressure. As result of exposure to a sufficiently high temperature or pressure, the configuration of the layers of the activatable environmental sensor print media may be altered. While layers are shown, it will be appreciated that approaches may be employed, e.g., using walls that prevent lateral movement of reactants that are broken by activation. The materials and thermal print head may be tuned, so that the activation takes place at the same, lower, or higher temperature than the conventional thermal printing process. As a result of the configuration of the layers of the activatable environmental sensor print media being altered, the activatable environmental sensor print media is activated, and may then operate as an environmental exposure indicator, which is configured to provide an indication of the historical exposure of the activatable environmental sensor print media to the predetermined environmental stimulus that occurs after activation. In indicators where thermal print regions and activatable indicator overlap, it may be advantageous to have materials with significantly different response characteristics, so that the conventional printing and activatable media can each be triggered without activating the other, e.g., one may require a higher temperature to be triggered, while the other responds to a lower temperature but requires a longer exposure time. Alternatively, the materials may be place in different areas of the printable medium.

### Activatable Environmental Indicator

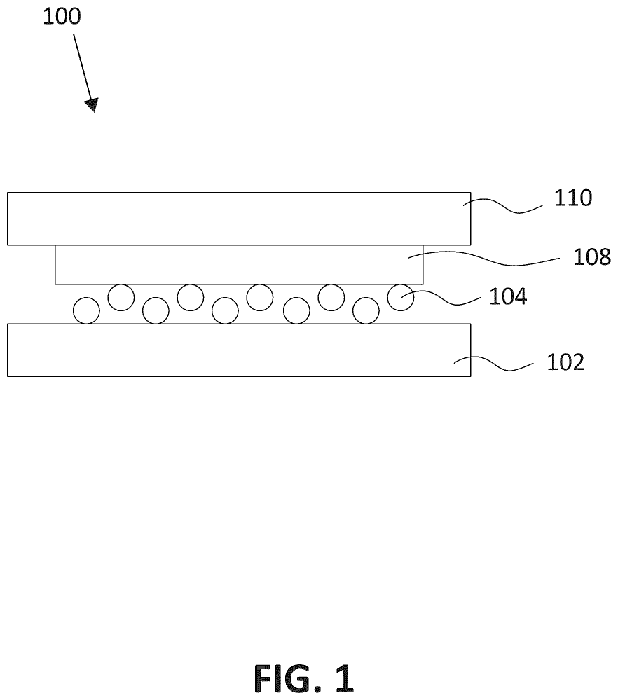

FIG. 1 illustrates a perspective view of the layers of an example activatable environmental indicator (e.g., an activatable environmental sensor print medium) 100. Optionally, the medium may contain conventional elements of a thermal print media, e.g., it may be constructed by adding environmental indicator components to a conventional thermal print media components, so that the print medium can still be printed using a conventional thermal printing process. Optionally, the medium may have a predetermined pattern, with conventional thermal print media structure in some predetermined locations, and with environmental indicator materials and activatable microcapsules in other locations. Alternatively, the conventional print media elements and environmental indicators may, in some cases overlap.

The activatable environmental indicator (e.g., an activatable environmental sensor print medium) 100 may include a base substrate 102, microcapsules 104 containing an environmental indicator material 106, a clear overlaminate film 108, and, in some embodiments, a top viewing layer 110.

The substrate 102 may be a printable substrate, e.g., a web material, e.g., paper such as a cellulose paper, polymer film substrate, a metallic layer, such as a metallic aluminum layer or an absorbent substrate. In some examples, the substrate 102 may have a thickness in a range of about 10 mm to about 20 mm, from about 1 mm to about 10 mm or from about 10 mm to about 20 mm. The substrate 102 may be one of a Polyolefin, polyamide, polypropylene, polyester Polyimide, Polyart synthetic paper, nylon, or PPG Teslin paper. In an example, there may be a topcoat applied to the substrate 102. Optionally, the substrate 102 may further include a release liner and/or an adhesive backing to allow the activatable environmental indicator (e.g., an activatable environmental sensor print medium) 100 to be selectively attached to surfaces, e.g., as a label. Depending the application, the activatable environmental indicator (e.g., an activatable environmental sensor print medium) 100 may be provided as a continuous web of material that may be cut, or that may be perforated for easy separation into individual indicators, or as precut label print stock in a desired form factor. In some methods as described further below, information may be printed onto the label print stock to product a printed label. The information is printed using a direct thermal printer which may also apply the activation event required to activate the microcapsules 104.

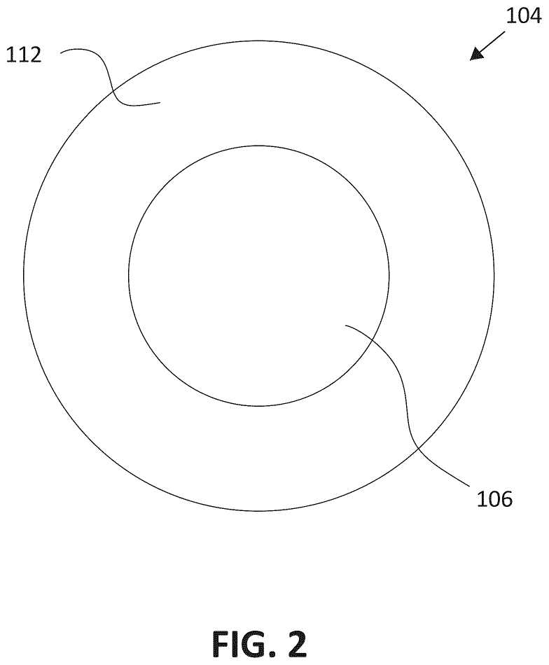

Atop or embedded within the substrate 102 are the microcapsules 104 containing the environmental indicator material 106 (shown in FIG. 2). The microcapsules 104 can be selectively disposed on the substrate 102 in designated area(s) and/or can be disposed on the substrate 102 to generally coat the substrate 102. There are a plurality of methods to deposit the microcapsules 104 onto the substrate 102. One method is a drawdown coating method. The method includes applying the microcapsules 104 along a width of the substrate 102 and then spreading the microcapsules 104 along the substrate 102 with a drawdown rod. The drawdown rod spreads the microcapsules 104 along the substrate 102 to a thickness to form a transfer layer of the microcapsules 104. The microcapsules 104 can then dry to the substrate 102. In at least one aspect, the microcapsules 104 are added to a wax layer and applied to the substrate 102 using the drawdown coating method. In certain embodiments, other methods of manufacture may be used. Flexographic printing cylinders and rollers may be used to coat material onto the substrate 102, then the substrate 102 may be cut and/or wound for loading into a printer. Retransfer methods may also be used, such as ink jetting material onto the substrate 102 or depositing the microcapsules 104 on the substrate 102 using a thermal transfer apparatus.

The activatable environmental indicator (e.g., an activatable environmental sensor print medium) 100 may include a clear overlaminate film 108 isolating and/or protecting the microcapsules 104. The clear overlaminate film 108 is an overlay component that overlays the microcapsules 104 and substrate 102. The overlaminate film 108 may be one of Fasson Faslam clear polypropylene, Avery Dennison® DOL series vinyl (PVC), any conformable overlaminate films, Apco PET or BOPP overlaminate films. The clear overlaminate film 108 allows a user to view through the clear overlaminate film 108 to see the layers below including the substrate 102 and microcapsules 104 while isolating and/or protecting the layers such that the layers (e.g., the substrate 102 and microcapsules 104 can be seen, but not touched. Depending on the desired application, the clear overlaminate film 108 may optionally be ultraviolet (UV) blocking, water resistant, hermetically sealed, chemically resistant, or merely a barrier to physical abrasion to protect the layers below the overlaminate film 108.

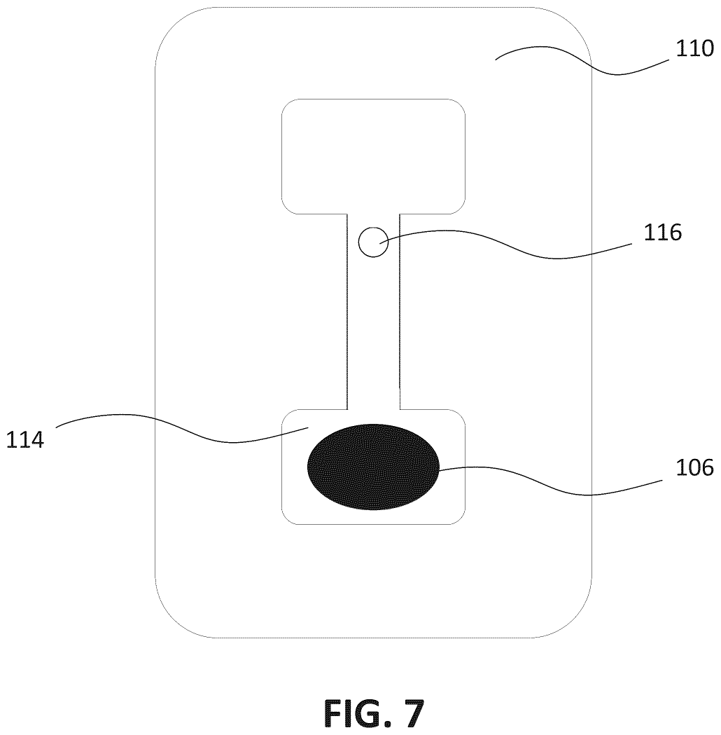

Finally, in some embodiments, the top viewing layer 110 may be placed atop the clear overlaminate film 108. The top viewing layer 110 may be any material suitable for displaying the microcapsules 104 and environmental indicator material 106, e.g., porous materials for bar codes printed using inks, etchable materials for laser-etched bar codes, paper, nylon, vinyl, other synthetic polymers such as polytetrafluoroethylene (“PTFE”), or other materials that are suitable for receiving and displaying the microcapsules 104 and environmental indicator material 106. The top viewing layer 110 may, for example, be paper or film (e.g., nylon, vinyl, synthetic polymer material, carbon fiber, Teslin synthetic paper, polyethylene (“PE”), polypropylene (“PP”), polytetrafluoroethylene (“PTFE”), polyester, polyethylene, polyolefin, polyimide, vinyl, acrylic film, polypropylene, non-woven nylon, coated and non-coated direct thermal paper, printable polyethylene terephthalate (“PET”), oriented polypropylene (“OPP”), biaxially oriented polypropylene (“BOPP”). In some embodiments, the top viewing layer 110 may be printed on with ink jetting material onto the substrate 102 or can be coated with a thermochromic material. Additionally, the top viewing layer may include holes or viewing windows 116 (e.g., as shown in FIGS. 7-11 and 13-20) as described further below.

### Microcapsules

FIG. 2 illustrates a cross-sectional view of a microcapsule 104 wherein the microcapsule 104 contains a shell 112 encapsulating the internal environmental indicator material 106. The microcapsule 104 may be any size, but in one such embodiment, has an outer diameter length between 50 to 700 μm or between 50 to 500 μm or between 50 and 250 μm. The shell 112 of the microcapsule 104 may have any thickness, but in one such embodiment, has a thickness of between 5 to 25 μm. The payload, or the ratio of the total weight of the environmental indicator material 106 within the microcapsule 104 to the entire weight microcapsule 104 including the environmental indicator material 106 contained within the microcapsule 104, can range from 50% to 90%. It will be appreciated that a variety of microcapsule shell 112 materials may be chosen, depending on the application, the type of activation, and the nature of the environmental indicator material 106. In general the microcapsules 104 should resist the passage, whether by flow, diffusion, or migration, of the environmental indicator material 106 prior to activation. For example, the microcapsules 104 may be a wax, e.g., an alkane wax, or other acid resistant compound having a relatively high melting point, e.g., fatty acid amide, an ester or Elvax EVA resin. For example, the melting point may be in a range of about 50° C. to about 300° C., from about 100° C. to about 300° C., from about 150° C. to about 300° C., from about 200° C. to about 300° C., from about 250° C. to about 300° C.

In another example, the microcapsules 104 may be polymer coating having a high glass transition temperature (Tg) e.g. Polysulfone. For example, the glass transition temperature may be in a range of about 50° C. to about 300° C., from about 100° C. to about 300° C., from about 150° C. to about 300° C., from about 200° C. to about 300° C., from about 250° C. to about 300° C. For example, polysulfone, with a Tg of about 190 C may be used. In additional examples, the microcapsules 104 may be one of Styrene Maleic Anhydride (SMA), Polyphenylene Ether (PPE), Cellulose Acetate, Cellulose Diacetate, Polyarylate, Polyamide, Polycarbonate, polyether ether ketone, Polyether Sulfone, PET, PFA, polymethyl methacrylate (PMMA) or Polyimide. In another example, the microcapsules 104 are a low molecular weight polymer gel having a high melting point, e.g., fatty acid amide, an ester or Elvax EVA resin. For example, the melting point may be in a range of about 100° C. to about 300° C., from about 150° C. to about 300° C., from about 200° C. to about 300° C., from about 250° C. to about 300° C. Additionally, in some examples, the polymer gel has a molecular weight in a range from about 1 g/mol to 100,000 g/mol, from about 3,500 g/mol to 6,000 g/mol and from about 200 g/mol to 2,000 g/mol. Alternatively, the microcapsules 104 may be a gel, gelatin, protein, polyurca formaldehyde, polymelamine formaldehyde, wax material, melamine, or an emulsion. The microcapsules may be available in wet and dry formulations. Polymelamine and polyurea formaldehyde can both be used for encapsulations via interfacial polymerization, which uses two immiscible phases. Once separated in the same vessel, a reaction is initiated at the interface of the two immiscible phases in the presence of an initiator and the material to be encapsulated. As polymerization occurs, microcapsules form around the core material. The microcapsule 104 releases the environmental indicator material 106 upon rupturing the microcapsule 104.

FIG. 2 illustrates the microcapsule 104 initially in an unactivated form, capable of being configured to transition to an activated form when activated through exposure to an activating event, e.g., the heat, pressure, and/or heat and pressure of a thermal print head. In the unactivated form, the microcapsule 104 maintains separation between the environmental indicator material 106 and any external environmental stimuli and/or contains a response of the environmental indicator material 106 in response to any external environmental stimuli.

The activatable environmental indicator (e.g., an activatable environmental sensor print medium) 100 may be activated through exposure of the microcapsules 104 to an activation event. The activation event may cause the fracturing, melting, breaking, dissolving, subliming, or becoming porous, allowing the release of its contents. For example, the activation event may be an application of at least one of an activation heat and an activation pressure. In some examples, the microcapsule 104 may be selectively activated, e.g., by activating only a portion of the microcapsules, the microcapsules in particular locations. In some examples, the temperature threshold for activation may be from about 0° C. to 300° C., from about 90° C. to 110° C., from about 100° C. to 200° C., from about 100° C. to 300° C., and from about 200° C. to 300° C. Activation may be achieved by applying a high temperature for a very short interval, e.g., a few milliseconds. In this manner, even if the temperature needed to activate the device exceeds the temperature that a temperature exposure indicator is configured to indicate, the exposure may be so short that the indicator itself is not affected. For example, the mass or heat of fusion of the indicator may be much greater than the mass or heat of fusion of a barrier that needs to be removed, allowing a short exposure to high temperature to remove or alter the microcapsule 104 without significantly affecting the environmental indicator material 106 itself. Typical thermal print heads have temperatures in the range from about 100° C. to 300° C., which may be tuned downward for select applications to from about 100° C. to 200° C. They are typically exposed to the thermal print heads for a brief period of time, for example a few milliseconds. The microcapsules 104 itself responds when it reaches a temperature of in a range from about 0° C. to 150° C., from about 0° C. to 50° C., from about 50° C. to 100° C., from about 90° C. to 110° C., from about 100° C. to 150° C., from about 100° C. to 200° C. It will be appreciated that the activation heat ranges given are purely exemplary and the microcapsules 104 can be formed to response to other temperature ranges. In some cases, pressure may also contribute to the activation, e.g., by breaking microcapsules 104, either alone like an impact printer, or in combination with elevated temperature. In some examples, a user can use his/her hand and/or fingers to apply a required pressure as an activation event and/or can use a tool, such as a mallet or roller, to apply the required pressure. In some examples, the activation pressure required to activate the microcapsules 104 may be from about 1.5 to 8 pounds per square inch or from about 4 to 15 pounds per square inch. In some instances, the microcapsules 104 may be exposed to heat and pressure from a Zebra ZT100 direct thermal printer or other thermal printer, applying a pressure of approximately 8 pounds per square inch and a temperature of 300° C. As an example, the ZT100 direct thermal printer can apply between 4 to 20 pounds per square inch and heat a material up to about 320° C. It will be appreciated that the activation pressure ranges given are purely exemplary and the microcapsules 104 can be formed to respond to other pressure ranges.

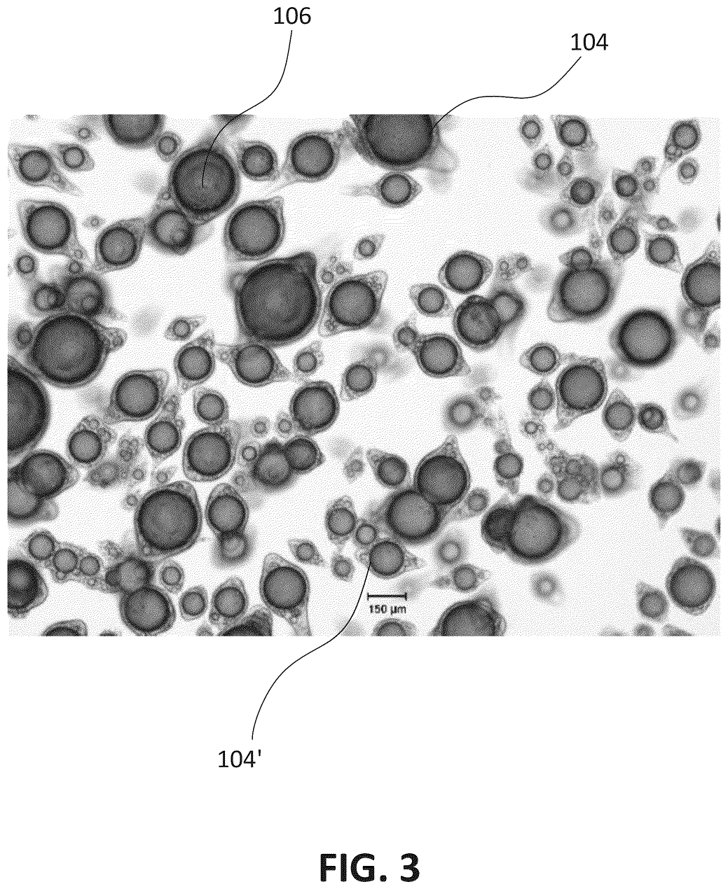

FIG. 3 illustrates a micrograph including one example of microcapsules 104 according to the present disclosure. In this example, the microcapsules 104 contain an environmental indicator material 106 such as those described below. The shell 112 of the microcapsule 104 may be any material as described above. The microcapsules 104 vary in size, but one such microcapsule 104′ is approximately 150 μm. There are microcapsules 104 that are both bigger and smaller than 150 μm.

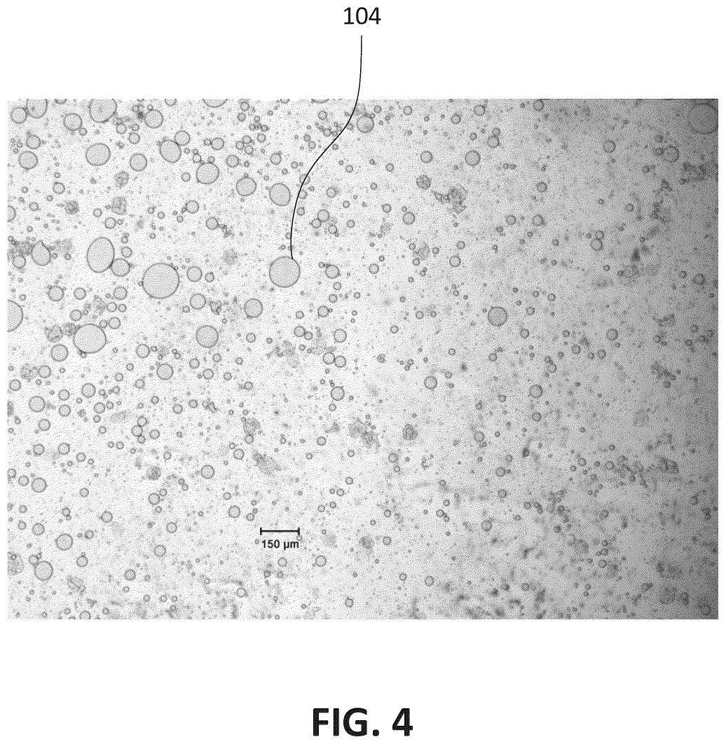

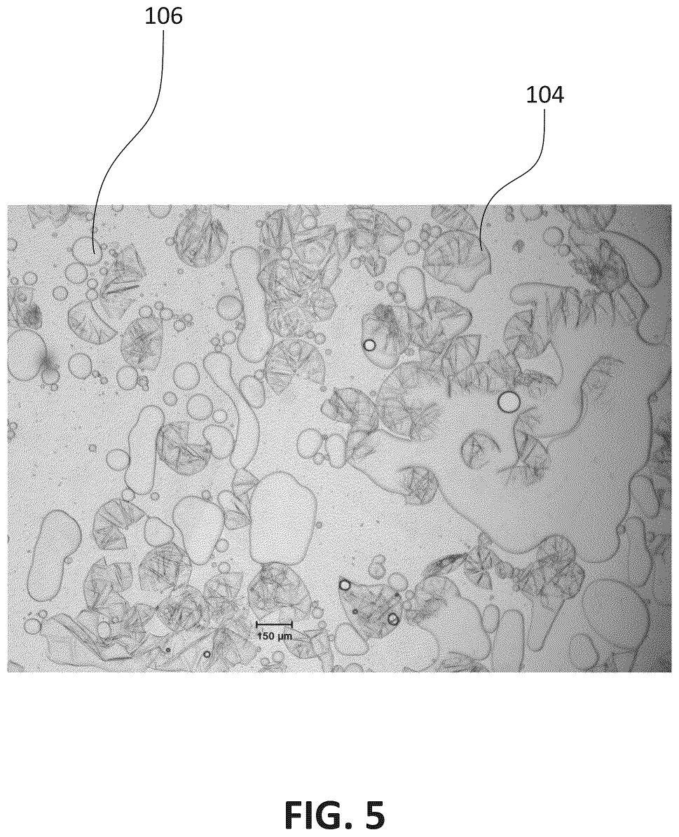

FIG. 4 illustrates another micrograph including another example of microcapsules 104 according to the present disclosure. In this example, the microcapsules 104 contain an environmental indicator material 106 such as those described below. The shell 112 of the microcapsule 104 may be any material as described above. The microcapsules 104 vary in size, but no microcapsule 104 exceeds approximately 150 μm. FIG. 5 illustrates a micrograph of the microcapsules 104 of FIG. 4 after exposure to an activation event.

In some examples, exposure to an activation event, the application of at least one of a heat and pressure, causes the microcapsules 104 to undergo a phase change and at least one of (i) flow away, (ii) sublimate, or (iii) become porous. In some examples, this may even result in complete or near-complete removal of the microcapsules 104. In other cases, portions of the microcapsules 104 may remain, e.g., as a porous layer that allows diffusion of the environmental indicator material 106.

The activation event may be carried out using an activation device. In some examples, the activation device may be a device that includes a processor, a memory coupled to the processor and a thermal print head, e.g., a conventional thermal printer with software modifications.

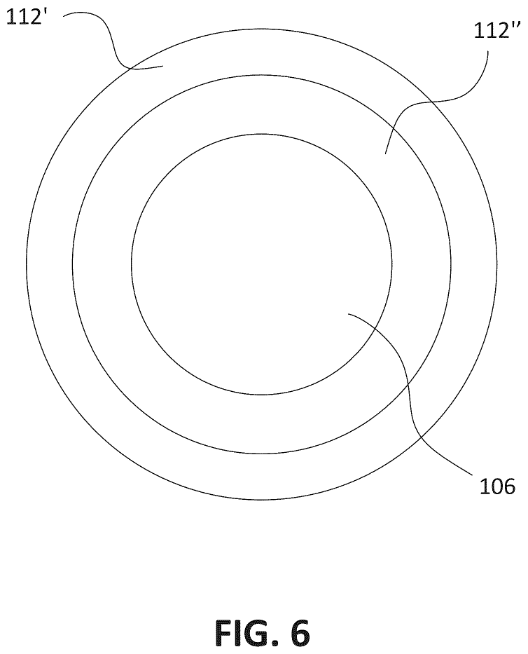

In some embodiments, there may be two or more shells 112 within a microcapsule 104 providing a barrier to the environmental exposure indicator 106. FIG. 6 shows an embodiment with two separate shells, 112′, 112″, encapsulating the environmental exposure indicator 106. Each shell 112′, 112″ may be configured to respond to a different activation event thus ensuring that the environmental indicator material 106 is only released after or in response to exposure to specific activation events. As one example, the first shell 112′ may be configured to respond to a certain activation pressure otherwise insulating the second shell 112″ from exposure to a certain activation heat to which the second shell 112″ responds. As one example, the first shell 112′ may be configured to respond to a first activation pressure and/or temperature and the second shell 112″ may be configured to respond to a second pressure and/or temperature that is higher than the first pressure and/or temperature. In this regard, the utilization of multiple shells can tailor the order of conditions to which the environmental indicator (e.g., an activatable environmental sensor print medium) 100 be exposed in order to activate.

There are many approaches to create the microcapsules 104 encapsulating the environmental indicator material 106. One such approach involves emulsifying materials such as a gel, gelatin, protein, polyurea formaldehyde, polymelamine formaldehyde, wax material, melamine, or an emulsion into an outer shell material. The environmental indicator is placed in the center of a disk. The outer shell material is then pumped into the center of a disk. The core material, such as an environmental indicator material 106, is surrounded by the outer shell 112 formed by the outer shell material as it enters the disk. The disk may have a plurality of nozzles on an exterior surface of the disk. The nozzles are connected to the center of the disk. The disk acts as a centrifuge and is rotated in a direction to produce microcapsules 104 with a narrow particle size distribution. Because of the centrifugal force exerted on the microcapsules, particles of certain sizes are thus separated. The microcapsule 104 size can be controlled by altering the rotation speed of the disk to produce larger or smaller particles. The microcapsules 104 have an outer shell material that surrounds a core material.

Alternative approaches to production of the microcapsules may include EHD coextrusion, stationary coextrusion, submerged nozzle coextrusion, pan coating, vibrating nozzle, centrifugal coextrusion, fluid bed coating, spray drying, rotating disk, in situ polymerization, solvent evaporation, interfacial polymerization, phase separation, simple coacervation, complex coacervation, sol-gel methods, liposomes, and nanoencapsulation.

### Environmental Indicator Material

The present disclosure includes an environmental indicator material 106 encapsulated in the activatable microcapsules 104, e.g., as shown in FIGS. 2-4 and 6. The microcapsules 104 may be utilized in order to prevent wicking, or migration, of the environmental indicator material 106 prior to an activation event even when the environmental indicator material 106 encapsulated in the microcapsules is exposed to a predetermined environmental stimulus (e.g., temperature or light). Alternatively, the microcapsule 104 may insulate the environmental indicator from a predetermined environmental stimulus (e.g. exposure to a particular gas, humidity, or light).

The environmental indicator material 106 may be any such material capable of exhibiting a detectable response upon the occurrence of a predetermined environmental stimulus, e.g., a material that when released interacts with another material to cause a change in color state, a material that liquefies and moves from its current location to another, a material that interacts with an electrical component to change an electrical property, etc. In some embodiments, the environmental indicator material 106 may be a thermochromic material, an alkane wax, dyed waxes, hydrochromic inks, specialized chemistry, polymer chemistry, polymers having side-chain crystallinity, and/or other phase change materials.

Most importantly, the environmental indicator material 106 is able to be tailored to change from at least a first material state to a second material state in response to a predetermined environmental stimulus. The material state may be a state of matter, e.g., changing from solid to liquid, a change in viscosity, how a material flows, color state, a transparency level, a hue, an electrical property, a conductivity, a capacitance, a distance the environmental indicator material 106 has traveled along the substrate, and combinations thereof. It will be appreciated that the above-mentioned material states are purely exemplary and other material state changes may exist. The response is detectable which may for example mean that it may be optically readable by a scanning device or readable by a human. It also may provide other detectable responses, e.g., a change in electrical property. The readability and human visibility of the environmental indicator material 106, in some examples, may only be detectable in one of the environmental indicator material's material states; for example the material may be transparent and effectively invisible in one state and have a readily visible opaque color in another state.

In some embodiments, there may be combinations of different environmental indicator materials 106 contained within microcapsules 104. This may include multiple types of microcapsules 104 containing multiple types of environmental indicator materials 106. The different environmental indicator materials 106 may be placed into microcapsules 104 to keep the environmental indicator materials 106 from pre-mature contact with each other, with a layer of an activatable environmental indicator (e.g., the activatable environmental indicator 100), with a wick (e.g., wick 114).

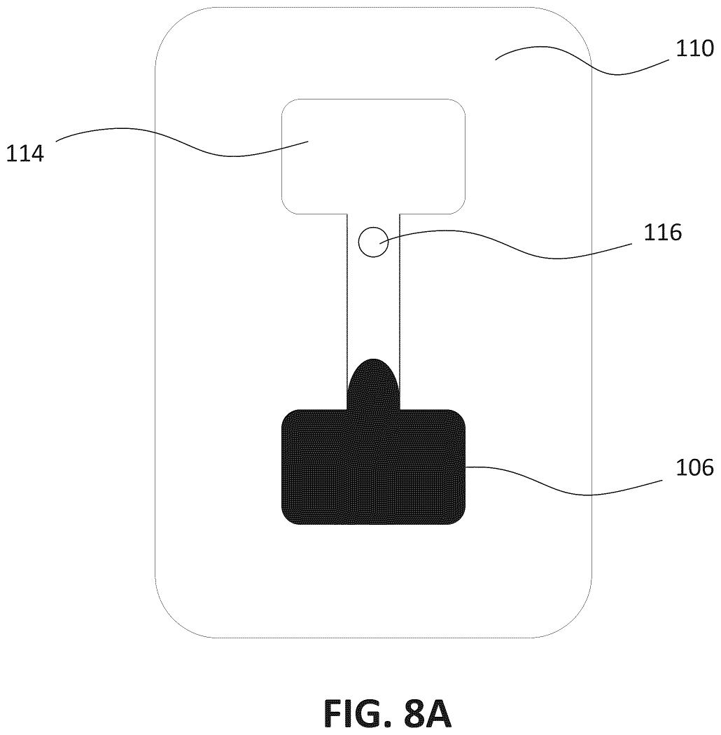

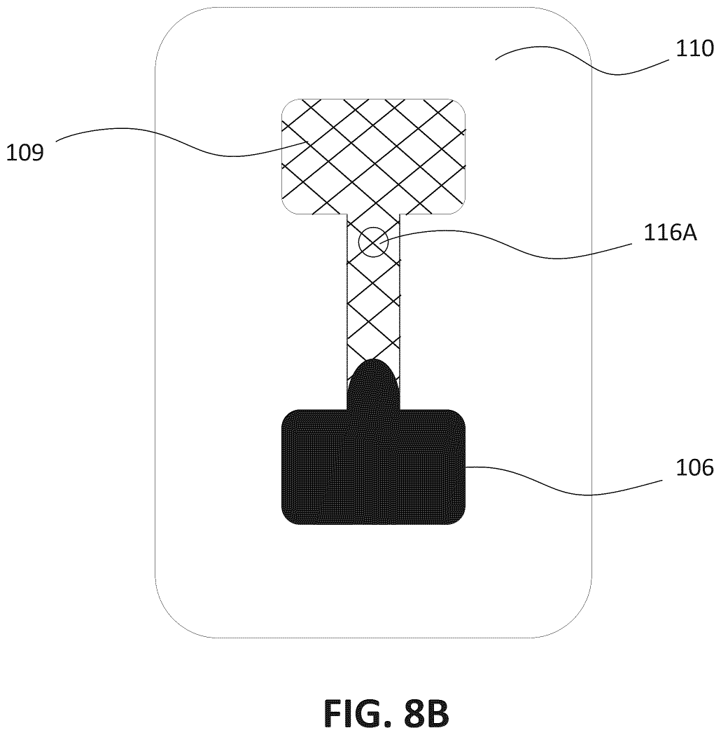

In one embodiment, the environmental indicator material 106 after being released from the microcapsules 104 can provide a visual indication that an activation event occurred, e.g., via one of the viewing windows 116. As an example, at least one of the microcapsules 104 can include an activation marker material 109 (e.g., FIG. 8B) that can provide a visual indication that the microcapsules 104 have been placed in the activated configuration. As another example, the environmental indicator material 106 can include the activation marker material 109 that can provide the visual indication. Upon release from the microcapsules 104 in response to an activation event, the environmental indicator material 106 and/or the activation marker material 109 can provide an indication that the microcapsules 104 have been placed in the activated configuration. Such an indication may be visible to the human eye and/or may be visible via an imaging device. In some embodiments in which the microcapsules 104 includes the environmental indicator material 106 and the activation marker material 109, the activation marker material 109 may not be distinguished from the environmental indicator material that provides a detectable response to a predetermined environmental stimulus. As an example, the environmental indicator material 106 and/or the activation marker material 109 can include a colorant (e.g., a dyc) having a predetermined color, a luminescent material, and/or a photochromic material. In some embodiments, microcapsules 104 can be deposited in an activation indicator area of the printable medium, where these microcapsules 104 include the environmental indicator material 106 and/or the activation marker material 109, e.g., that can be viewable through one of the viewing windows 116 after an activation event. In some embodiments, microcapsules 104 can be deposited in an environmental and/or activation indicator area of the printable medium, where these microcapsules 104 include the activation marker material 109 and microcapsules 104 including the environmental indicator material 106 can be deposited in an environmental indicator area that is separate from the activation indicator area. In some embodiments, the activation indicator area and the environmental indicator area can be positioned in proximity and/or adjacent to each other. By positioning the activation indicator area in proximity and/or adjacent to the environmental indicator area, the activation indicator area and the environmental indicator area can experience an activation event in a similar manner, e.g., both areas can experience the same or nearly the same activation temperature and/or activation pressure. For example, if an environmental indicator material is black when exposed to the relevant environmental stimulus, but transparent initially, a person will not be able to tell, at a glance that the device has been activated. By adding a yellow dye to at least some microcapsules, the area will turn yellow when activated, thereby making it clear to a user that the device has been activated, but without confusing the user that the relevant environmental exposure has occurred.

In one embodiment, the environmental indicator material 106 is a meltable solid configured to melt in response to a predetermined temperature above a threshold, forming a liquid that migrates along the substrate 102 for at least a predetermined distance when remaining at a temperature above the threshold for at least a predetermined time period. In some embodiments, the environmental indicator material 106 may include a colorant that migrates with the liquid environmental indicator material 106.

In another embodiment, the environmental indicator material 106 is a gel configured to, in response to a predetermined temperature above a threshold, change viscosity causing the gel to migrate along the substrate 102 for at least a predetermined distance when remaining at a temperature above the threshold for at least a predetermined time period. In some embodiments, the environmental indicator material 106 may include a colorant that migrates with the gel environmental indicator material 106. For example, the material may be a side-chain crystallizable polymer combined with an alkane wax and colored dye as described in of U.S. Patent Publication 20220178761 applied for by Temptime Corporation, a Zebra Technologies company. Some side-chain crystallizable (SCC) polymers useful in the practice of the present disclosure, alone or in combination, and methods that can be employed for preparing them, are described in O'Leary et al. “Copolymers of poly(n-alkyl acrylates): synthesis, characterization, and monomer reactivity ratios” in Polymer 2004 45 pp 6575-6585 (“O'Leary et al.” herein), and in Greenberg et al. “Side Chain Crystallization of n-Alkyl Polymethacrylates and Polyacrylates” J. Am. Chem. Soc., 1954, 76 (24), pp. 6280-6285 (“Greenberg et al.” herein). The disclosure of each of O'Leary et al. and Greenberg et al. is incorporated by reference herein for all purposes. Suitable side-chain crystallizable (SCC) polymers useful in the practice of the present disclosure are also described in U.S. Pat. No. 5,156,911 at column 5, lines 67 to column 7, line 13, which disclosure is incorporated by reference herein for all purposes. Some useful side-chain crystallizable polymers, and monomers for preparing side-chain crystallizable polymers, are also available from commercial suppliers, for example, Scientific Polymer Products, Inc., Ontario, N.Y., Sigma-Aldrich, Saint Louis, Mo., TCI America, Portland Oreg., Monomer-Polymer & Dajac Labs, Inc., Trevose, Pa., San Esters Corp., New York, N.Y., Sartomer USA, LLC, Exton Pa., and Polysciences, Inc. Other materials may be SCC's alone without SCCs, or alkane waxes blended without SCCs.

### Example Time Temperature Exposure Indicator

The activatable indicator of the present disclosure may be combined with the time temperature indicator of U.S. Patent Publication 20220178761 applied for by Temptime Corporation, a Zebra Technologies company.

In some embodiments such as those shown in FIGS. 7-12, the environmental indicator material 106 may be configured to migrate along a wick 114. The wick 114 may be on or in the substrate 102 and positioned near the microcapsules 104 such that upon activation the environmental indicator material 106 may migrate along the wick 114. Thus, the wick 114 can be used as a tool of measurement to determine the extent or duration of the exposure the environmental indicator material 106 has had to the predetermined environmental stimulus. With a suitable material the migration of the environmental indicator material 106 along the wick may indicate the historical exposure to the predetermined environmental stimulus for a particular time period; the longer the exposure the more the material may travel down the wick.

The wick may be any material capable of allowing the environmental indicator material to migrate upon, including filter paper; pulverized filter paper; fine silica gel; porous films containing polytetrafluorocthylene resin or silica gel; TESLIN microporous synthetic sheet; non-woven, spun bonded materials including non-woven, spun-bonded high-density-polyethylene, polypropylene and polyester, or non-woven, spun bonded blends of any two or more such polymers. It will be appreciated that the use of a wick is purely exemplary and transport elements may be known to an artisan practicing ordinary skill in the art.

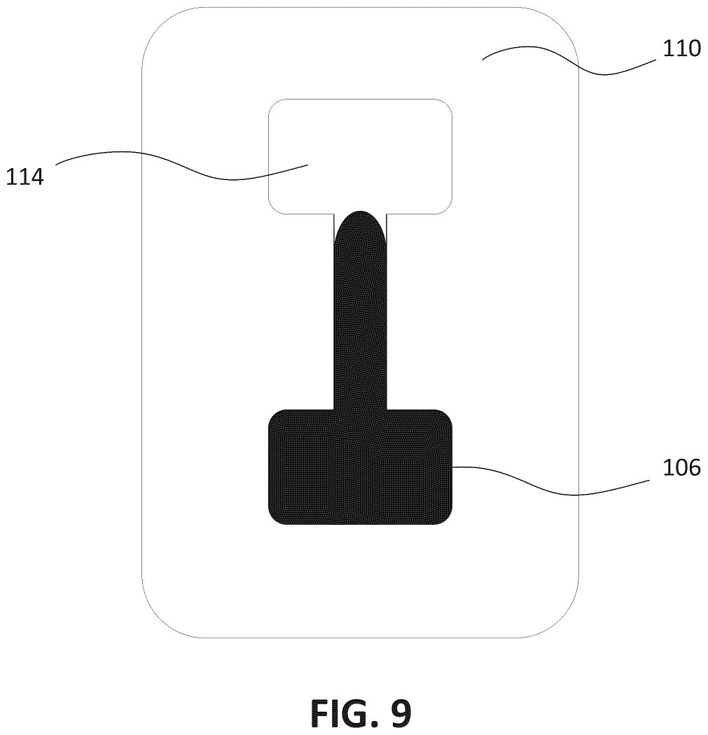

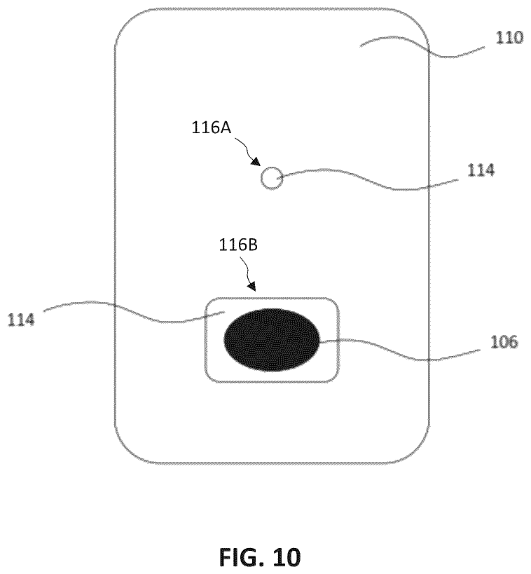

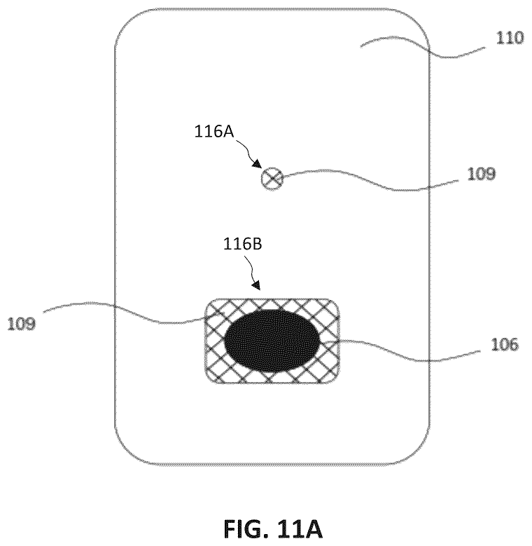

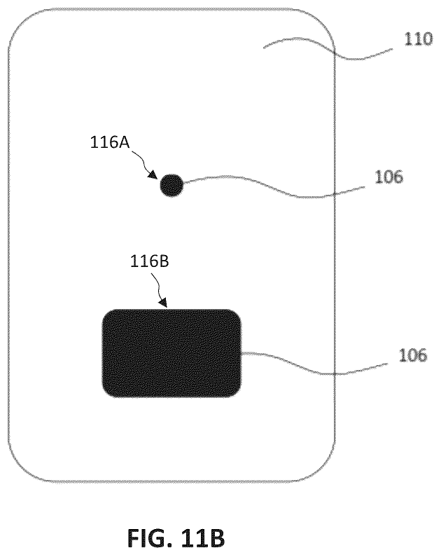

In one example, the activatable indicator may include a substrate 102, a wick 114 supported by the substrate 102 and microcapsules 104 containing an environmental indicator material 106 supported by the substrate. When the activatable indicator is initially provided, the environmental indicator material 106 comprises a solid indicator material, e.g., a mixture of a synthetic polymeric material and a wax material. The microcapsules 104 are configured to respond to an activation heat, an activation pressure, or a combination of an activation heat and activation pressure by fracturing, melting, breaking, dissolving, or becoming porous. This response releases the environmental indicator material 106 from the microcapsules 104. In FIG. 7, the unactivated microcapsules 104 containing the environmental indicator material 106 lay atop the wick 114 (e.g., one end of the wick 114). After the microcapsules 104 are activated, the released environmental indicator material 106 may begin to migrate along the wick 114 as shown in FIG. 8A. Alternatively, the released environmental indicator material 106 may be formulated to remain where the microcapsules are disposed (e.g., at an end of the wick 114) until or unless the released environmental indicator material 106 is exposed to the predetermined environmental stimulus at which time the released environmental indicator material can migrate along the wick 114, e.g., while they remain at a temperature below the melting of the environmental indicator material, or a temperature above which the environmental indicator material wicks freely with a reduced viscosity. After a given period of time, the environmental indicator material 106 may sufficiently migrate along the wick 114 such that the wick 114 is mostly covered in the environmental indicator material 106 as shown in FIG. 9. In embodiments with a top viewing layer 110, the distance the environmental indicator material 106 migrates along the wick may correspond to a viewing window 116A within the top viewing layer 110. FIG. 10 shows an unactivated activatable environmental indicator (e.g., an activatable environmental sensor print medium) 100 which can be seen by a lack of environmental indicator material 106 and/or an activation marker material in the viewing window 116A. FIG. 11A shows an activated activatable environmental indicator (e.g., an activatable environmental sensor print medium) 100 that has not been exposed to a predetermined environmental stimulus, e.g., to a temperature above the melting point of the environmental indicator material, subsequent to an activation event such that environmental indicator material and/or an activation marker material is viewable view the viewing window 116B and the environmental indicator material is not viewable via the viewing window 116A, and FIG. 11B shows an activated activatable environmental indicator (e.g., an activatable environmental sensor print medium) 100 that has been exposed to a predetermined environmental stimulus such that the environment indicator material has migrated along the wick 114 and is now viewable in the view area 116A. By the use of a wick, a user may optically determine whether an activation event has occurred and whether the environmental indicator material 106 has been exposed to a predetermined environmental stimulus.

The environmental indicator material 106 provides an indication of the exposure of the activatable environmental indicator (e.g., an activatable environmental sensor print medium) 100 to a predetermined environmental stimulus and/or provides an indication of duration of time elapsed since an activation event. In their initial non-activated configuration such as that shown in FIG. 4. The microcapsules 104 may prevent the environmental indicator material 106 from operating to provide the indication of exposure to the predetermined environmental stimulus, e.g. by preventing an environmental indicator material state change (e.g., by separating two materials that would otherwise interact, by keeping the environmental indicator materials from being exposed to the relevant predetermined environmental stimulus, or by preventing movement, flow, or wicking of the indicator material after it changes to a mobile state, such as a liquid, or by hiding the indicator material (if the microcapsules were opaque and the indicator material color changes in response to environmental exposure).

Upon activation, the microcapsules 104 are ruptured, and the environmental indicator material 106 is exposed to the environment and thus is able to respond to the predetermined environmental stimulus when it occurs. As one such example, FIG. 4 illustrates an environmental indicator material 106 contained within microcapsules 104 prior to an activation event. FIG. 5 illustrates the environmental indicator material 106 having been released from the microcapsules 104 following an activation event. In this example, the microcapsules 104 have been ruptured from exposure to an activation pressure or an activation heat.

The environmental indicator material 106 is configured to melt at a predetermined threshold temperature, and then move along the wick 114 when melted. The melted material is chosen so that it takes a predetermined amount of time to move along the wick 114 at or about the predetermined threshold temperature, and so that the indicator changes indicator state at the predetermined amount of time.

The predetermined threshold temperature may be chosen at any suitable range depending on the applications. For example ranges may be chosen to show whether a product has been removed from a freezer, or a refrigerator, or exposed to another higher temperature. Example predetermined threshold temperatures may be about −10° C. to about 80° C., and preferably from about 0° C. to about 70° C., from about 0° C. to about 60° C., from about 1° C. to about 30° C., from about 2° C. to about 20° C., from about 5° C. to about 15° C., from about 8° C. to about 12° C., from about 9° C. to about 11° C., e.g., about 10° C., from about 0° C. to 150° C., from about 0° C. to 50° C., from about 50° C. to 100° C., from about 90° C. to 110° C., from about 100° C. to 150° C., from about 100° C. to 200° C. It will be appreciated that the activation heat ranges given are purely exemplary and other ranges may be known to an artisan practicing ordinary skill in the art. A predetermined threshold temperature around 10° C. may be used to show removal from refrigeration. The wick 114 and the environmental indicator material 106 are configured so that exposure to at least the predetermined threshold temperature for at least a predetermined exposure time results in at least a predetermined amount of movement of the environmental indicator material 106 along the wick 114.

In some cases, pressure may also contribute to the activation, e.g., by breaking microcapsules 104, either alone like an impact printer, or in combination with elevated temperature. In some examples, the activation pressure required to activate the microcapsules 104 may be from about 1.5 to 8 pounds per square inch or from about 4 to 15 pounds per square inch. It will be appreciated that the activation pressure ranges given are purely exemplary and other ranges may be known to an artisan practicing ordinary skill in the art.

The environmental indicator material 106 may include a synthetic polymeric material, e.g., a polymer having side chain crystallinity (SCC). Two or more SCC polymers may be blended in order to tune the properties of the material. In an example embodiment, the polymer having side chain crystallinity (SCC) is a polymer or a copolymer having at least one crystallizable side chain selected from the group consisting of a C4-30 aliphatic group; a C6-30 aromatic group; a linear aliphatic group having at least 10 carbon atoms; a combination of at least one aliphatic group and at least one aromatic group, the combination having from 7 carbon atoms to about 30 carbon atoms; a C10-C22 acrylate; a C10-C22 methacrylate; an acrylamide; a methacrylamide; a vinyl ether; a vinyl ester; a fluorinated aliphatic group having at least 6 carbon atoms; and a p-alkyl styrene group wherein the alkyl group has from about 8 carbon atoms to about 24 carbon atoms. Examples of such synthetic polymeric material are described in detail in U.S. Pat. Nos. 9,546,911 and 8,671,871, which are fully incorporated herein by reference for all purposes.

The synthetic SCC polymer may be selected so that it is solid at or below the stop temperature and is, or can become, a viscous liquid when at or above the predetermined threshold temperature. Such synthetic SCC polymer is meltable, and can also be hydrophobic, if desired. The synthetic SCC polymer may have a molecular weight of at least about 1,000 Da. In an example embodiment, the synthetic SCC polymer can have desirably sharp transitions from a solid state to a liquid state. When the indicator returns to a temperature at or below the stop temperature, the material may re-solidify, and thus stop moving.

The wax material may be at least one of an alkane wax, an alkyl ester, a natural wax, or a modified natural wax. In an example embodiment, the wax material comprises at least one of an undecane, a dodecane, a tridecane, a tetradecane, a pentadecane, a hexadecane, a heptadecane, an octadecane, a nonadecane, an eicosane, a hencicosane, a hexanoic acid, ethyl lactate, a paraffin wax, a microcrystalline wax, carnauba wax, beeswax, Chinese wax, shellac wax, spermaceti, tallow, palm wax, soy wax, 15 lanolin, wool grease, a waxy polymer, a waxy copolymer, a polyolefin, polyethylene, polypropylene, an ethylene-vinyl acetate copolymer, an ethylene-acrylic acid copolymer, and combinations thereof. In some disclosed examples the wax material is a blend of two alkane waxes. For example, the wax material may be a blend of hexadecane and pentadecane in a weight ratio of hexadecane to pentadecane from about 40:60 to about 1:95, from about 30:70 to about 10:90, from about 20:80 to about 10:90, or more preferably about 15:85. Other ranges may be chosen to tune the properties of the material. It will be appreciated that other combinations and proportions may also be employed. While other materials with the similar melting and flow properties as these wax materials might be employed, waxes like those disclosed herein generally tend to be stable, safe, have low volatility, and are easy to use in the manufacturing process.

In an example embodiment, a ratio of the synthetic polymeric material to the wax material is in a range from about 10:90 to about 90:10, from about 20:80 to about 80:20, from about 30:70 to about 70:30, from about 40:60 to about 60:40, from about 50:50 to about 60:40 and preferably from about 52:48 to about 58:42, e.g., about 55:45.

In an example embodiment, the predetermined exposure time for the environmental indicator material 106 to reach the predetermined amount of movement along the transport element (e.g., the wick 114) at the predetermined threshold temperature is in a range of about 0.1-48 hours or even up to 72 hours or longer, about 1-24 hours, about 2-15 hours, about 2-10 hours, about 3-9 hours, or about 4-8 hours.

In an example embodiment, the predetermined threshold temperature is about 10° C., which corresponds to removal from a typical refrigerator unit, and the predetermined exposure time for the environmental indicator material 106 to reach the predetermined amount of movement along the transport element at the predetermined threshold temperature is in a range of about 4-8 hours. Other thresholds may be chosen, depending on the properties of the materials or host products being monitored and particular applications.

Atop the substrate 102, microcapsules 104, environmental indicator material 106, and wick 114, may be a clear overlaminate film 108. The clear overlaminate film 108 is an overlay component overlaying the substrate 102 and microcapsules 104. The overlaminate film 108 may be one of Fasson Faslam clear polypropylene, Avery Dennison® DOL series vinyl (PVC), any conformable overlaminate films, Apco PET or BOPP overlaminate films. The clear overlaminate film 108 allows a user to view through the clear overlaminate film 108 to see the layers below including the substrate 102 and microcapsules 104 while isolating and/or protecting the layers such that the layers (e.g., the substrate 102 and microcapsules 104 can be seen, but not touched. Depending on the desired application, the clear overlaminate film 108 may optionally be UV, blocking, water resistant, hermetically sealed, chemically resistant, or merely a barrier to physical abrasion.

Finally, in some embodiments, a top viewing layer 110 may be placed atop the clear overlaminate film 108. The top viewing layer 110 may be any material suitable for displaying the microcapsules 104 and environmental indicator material 106, e.g., porous materials for bar codes printed using inks, etchable materials for laser-etched bar codes, paper, nylon, vinyl, other synthetic polymers such as polytetrafluoroethylene (“PTFE”), or other materials that are suitable for receiving and displaying the microcapsules 104 and environmental indicator material 106. The top viewing layer 110 may, for example, be paper or film (e.g., nylon, vinyl, synthetic polymer material, carbon fiber, Teslin synthetic paper, polyethylene (“PE”), polypropylene (“PP”), polytetrafluoroethylene (“PTFE”), polyester, polyethylene, polyolefin, polyimide, vinyl, acrylic film, polypropylene, non-woven nylon, coated and non-coated direct thermal paper, printable polyethylene terephthalate (“PET”), oriented polypropylene (“OPP”), biaxially oriented polypropylene (“BOPP”). Additionally, the top viewing layer may include holes or viewing windows 116 (e.g., windows 116A-B).

### Example Humidity Indicator

In another example, the microcapsules 104 may be used in an activatable material. A humidity sensitive material, e.g., a hygroscopic or hydrophilic material, can be encapsulated in a moisture resistant microcapsule. Example indicator materials for the indicator may include hydrochromic inks, polar protic solvents, polar pigments, and/or polar polymers. Example materials for the shell may include a gel, gelatin, protein, polyurea formaldehyde, polymelamine formaldehyde, wax material, melamine, or an emulsion. The shell materials may also be hydrophilic.

The microcapsules 104 itself responds when it reaches a temperature of in a range from about 0° C. to 150° C., from about 0° C. to 50° C., from about 50° C. to 100° C., from about 90° C. to 110° C., from about 100° C. to 150° C., from about 100° C. to 200° C., from about 200° C. to 300° C. It will be appreciated that the activation heat ranges given are purely exemplary and other ranges may be known to an artisan practicing ordinary skill in the art. In some cases, pressure may also contribute to the activation, e.g., by breaking microcapsules 104, either alone like an impact printer, or in combination with elevated temperature. In some examples, the activation pressure required to activate the microcapsules 104 may be from about 1.5 to 8 pounds per square inch or from about 4 to 15 pounds per square inch. It will be appreciated that the activation pressure ranges given are purely exemplary and other ranges may be known to an artisan practicing ordinary skill in the art.

### Example Cumulative Heat Exposure Indicator

In another example, the microcapsules 104 may be used in an activatable cumulative heat exposure indicator. For example, modifications may be made to the cumulative heat exposure indicator of U.S. Pat. No. 9,011,794 of Freshpoint Quality Assurance Ltd. This indicator relies on etching of a metal substrate by phosphoric acid or other etchant material. The rate of etching is sensitive to temperature and provides an indication of cumulative temperature exposure. For example, etching of the metal layer with the etchant can cause a change, e.g., in an optical property (absorption, transmission, reflectivity, color, hue, etc.) of the cumulative heat exposure indicator and/or in an electrical property (conductivity/resistance, capacitance, etc.) of the cumulative heat exposure indicator. However, by encapsulating the phosphoric acid or other etchant in microcapsules (e.g., as the environmental indicator material 106 in the microcapsules 104), the microcapsules can be disposed on the metal substrate and etchant encapsulated in the microcapsules will not etch the metal substrate until the microcapsules are placed in the activated configuration to release etchant and after the released etchant onto the metal substrate and the released etchant is subsequently exposed a predetermined environmental stimulus (e.g., temperatures above a response temperature of the environmental indicator material). Using this approach, the cumulative heat exposure indicator including the microcapsules disposed on the metal substrate can be stored at temperatures above the response temperature without causing a detectable response while in the non-activated configuration, and after the microcapsules are ruptured, releasing the etchant, in response to an activation event, the indicator can operate normally (e.g., be responsive to temperature to produce a detectable response in response to etching of the metal substrate). The microcapsules 104 may be any material that inhibits wicking prior to activation that does not have an affinity for the dye or wax. In this manner an improved cumulative heat exposure indicator may be provided.

### Example Time-Temperature Indicators

FIGS. 7-12 show an example indicator based on the Zebra/Temptime Limitmarker D-A time-temperature exposure indicator. The indicator material used is a solvent based SCC with an Alkane Wax blend combined with a colored dye, similar to U.S. Patent Publication 20220178761 applied for by Temptime Corporation, a Zebra Technologies company. FIGS. 7-9 show the internals of the indicator prior to the addition of the top viewing layer 110. FIG. 10 shows the same indicator with the top viewing layer 110—the viewing window 116A, white dot indicates a temperature excursion has not occurred. FIGS. 8-9 show the internals of the same indicator after exposure to excess temperature for two different periods of time. FIG. 8A shows the internals of the same indicator soon after exposure to excess temperature, whereas FIG. 9 shows the internals of the same indicator after a longer period of time since the exposure to excess temperature than FIG. 8A. The environmental indicator material 106 melts and transits the wick 114 carrying the colored dye with it. With the top viewing layer 110 on in FIG. 11B, the viewing window 116A appears in a color different from than the initial color shown in FIG. 10, such as red, showing to a user that the indicator has been exposed to excess temperature for more than the minimum time. It will be appreciated that the colors white and red are purely exemplary and other color combinations may be used in the indicator to signify exposure. FIGS. 8B and 11A-B show an alternative embodiment where at least some of the microcapsules 104 contain an activation marker material 109, e.g., a dye of a different color than the dye described above with respect to an example of the environmental indicator material 106 and that freely diffuses at a lower temperature than the environmental indicator material. As shown in FIG. 11A, when the microcapsules 104 are ruptured, activation marker material 109 quickly diffuses along the wick 114 changing the color of the wick in the viewing windows 116 (e.g., windows 116A-B). For example, if the environmental indicator material normally carries a black dye, a yellow dye (illustrated using cross hatching) with a much lower melting temperature may also be included as the activation marker material 109. The activation marker material 109 may then rapidly diffuse turning the wick 114 yellow (as shown by the cross hatching, e.g., in FIGS. 8B and 11A). Observance of the yellow activation marker material 109 via one or more of the viewing windows 116 is a sign that the device had actually been activated (i.e., placed in an activated configuration) but has not yet been exposed to the specified predetermined environmental stimulus after activation, which is required for the environmental indicator material 106 to migrate along the wick 114 and be visible via one or more of the viewing windows (e.g., viewing window 116A in FIG. 11A-B). FIG. 11B shows the appearance of this indicator when it is has been activated and exposed to the specified predetermined environmental stimulus, with the top cover on the device. As shown in FIG. 11B, the environmental indicator material 106 has migrated along the wick 114 so that the environmental indicator material 106 is now viewable via the window 116A.

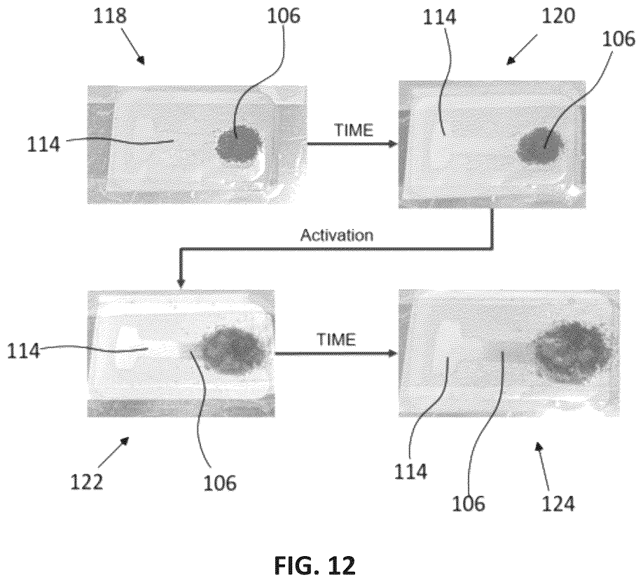

FIG. 12 shows the example indicator in several phases before activation and phases when exposed over time to a temperature above the melting point of the indicator material for an extended time. 118 illustrates an example indicator before an activation event. This structure is the internal structure similar to the Limitmarker D-A indicator mentioned above, without the covering material. As can be seen from the photo, the environmental indicator material 106 is contained in the reservoir and does not migrate. 120 shows the same indicator after activation by exposure to heat and pressure sufficient to rupture the microcapsules 104. When the environmental indicator material 106 is exposed to the same temperature as in FIG. 1, the environmental indicator material 106 melts and migrates along the wick 114, which will produce an observable indication of a temperature exposure in the Limitmarker indicator design. After yet more time, the environmental indicator material 106 will continue to further migrate along the wick 114 as shown in 122. Finally, the environmental indicator material 106 will reach a sufficient distance along the wick 114 such as in 124 that the observable indication of temperature exposure can be seen even with a top viewing layer 110 adhered to the indicator.

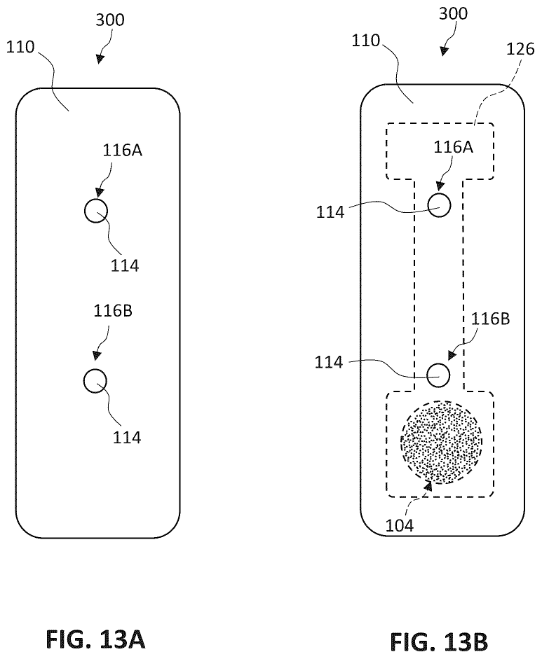

FIGS. 13-15 illustrate another example embodiment of an environmental indicator 300. FIGS. 13A, 14A, and 15A illustrate the top viewing layer 110 which conceals the components of the environmental indicator 300 below the top viewing layer 110, except the portions of the wick 114 (and overlaminate film) that are viewable via the windows 116A-B. FIGS. 13B, 14B, and 15B illustrate in dashed lines the wick 114, a perimeter 126 of the wick 114 under the top viewing layer 110. As shown the environmental indicator 300 can have a form that is similar to the form of other embodiments described herein, e.g., in FIGS. 1 and 7-12. As an example, the environmental indicator 300 can include a substrate (e.g., substrate 102 shown in FIG. 1), microcapsules 104 containing environmental indicator material 106 and/or activation marker material 109, the wick 114, overlaminate film (e.g., overlaminate film 108 shown in FIG. 1), and the top viewing layer 110. The wick 114 can be disposed on or embedded in the substrate and the microcapsules 104 can be deposit on, under, or proximate to the wick 114. A perimeter 126 of the wick 114 can be sealed, e.g., with an adhesive. As an example, the overlaminate film can be adhered to the substrate along the perimeter 126 of the wick 114. The top viewing layer 110 can be generally opaque such that the contents of the indicator that are under the top viewing layer 110 cannot be readily visible. The top viewing layer 110 can provide a printable surface upon which indicia (e.g., alphanumeric characters and/or barcode symbologies) can be printed. The top viewing layer 110 can also include the viewing windows 116 (e.g., viewing window 116A and 116B). As an example, the viewing windows 116 can allow for viewing of portions of the wick 114 (e.g., through the overlaminate film) and can be used to determine whether the environmental indicator is in the non-activated configuration, the activated configuration (e.g., in response to an activation event) and/or whether the environmental indicator material has been exposed to a predetermined environmental stimulus after environmental indicator material has been placed in the activated configuration (i.e., in the exposed configuration).

FIGS. 13A-B illustrate a state of the environmental indicator 300 in a non-activated configuration. As described herein, because the microcapsules 104, which are disposed proximate to a first end of the wick 114 are intact in the non-activated configuration, the environmental indicator material 106 remains contained within the microcapsules 104 and the environmental indicator 300 is non-responsive to the predetermined environmental stimulus. The environmental indicator 300 can be determined to be in the non-activated configuration via a visual indicator that is observable via the viewing windows 116 (e.g., the wick 114 is viewable and devoid of the environmental indicator material).

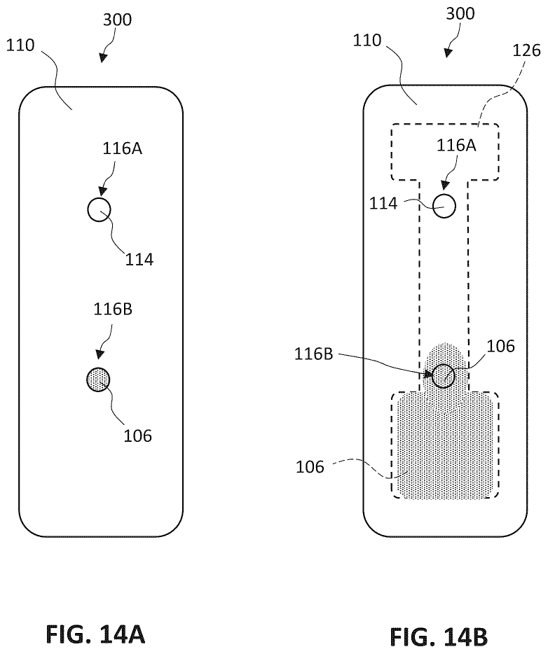

FIGS. 14A-B illustrate a state of the environmental indicator 300 in an activated configuration after an activation event causing the environmental indicator material 106 to be released from the microcapsules 104 and before the released environmental indicator material 106 is exposed to the predetermined environmental stimulus. As described herein, the perimeter 126 of the wick 114 can be sealed so that when the environmental indicator material 106 is released the environment indicator material 106 is confined to the wick 114. In response to the activation event, a portion of the released environmental indicator material 106 can be forced, by the activation event, to migrate along the wick 114 such that a portion of the environmental indicator material 106 is viewable via the viewing window 116B. As an example, when the activation event corresponds to applying pressure to the microcapsules 104, when the microcapsules burst or rupture, the pressure applied to the area including the microcapsules 104 can squeeze the environmental indicator material 106 and push it to other portions of the wick 114. When the environmental indicator material 106 is forced along the wick 114 in response to the activation event and is viewable via the viewing window 116B, the observability of the environment indicator material 106 via the viewing window 116B provides a visual indication that the environmental indicator 300 has been placed in the activated configuration, while the absence of the environmental indicator material 106 for the portion of the wick 114 viewable via the viewing window 116A can indicate that the released environmental indicator material 106 has not been exposed to the predetermined environmental stimulus. In some examples, the presence of the environmental indicator material in the viewing window 116B and the absence of the environmental indicator material in the viewing window 116A can be a visual indication that the environmental indicator is in the activated configuration.

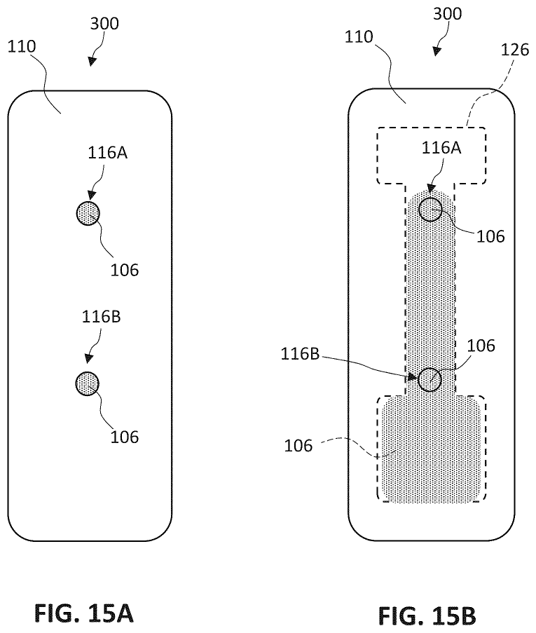

FIGS. 15A-B illustrate a state of the environmental indicator 300 in an activated configuration after an activation event causing the environmental indicator material 106 to be released from the microcapsules 104 and after the released environmental indicator material 106 is exposed to the predetermined environmental stimulus. As shown in FIGS. 15A-B, the environmental indicator material has diffused along the wick 114 towards a second end of the wick 114 such that the environmental indicator material 106 is viewable on the portion of the wick 114 that is viewable via the viewing window 116A which can be a visual indication that the released environmental indicator material 106 has been exposed to the predetermined environmental stimulus. The presence of the environmental indicator material in the viewing windows 116A and 116B can be a visual indication that the environmental indicator is in the exposed configuration.

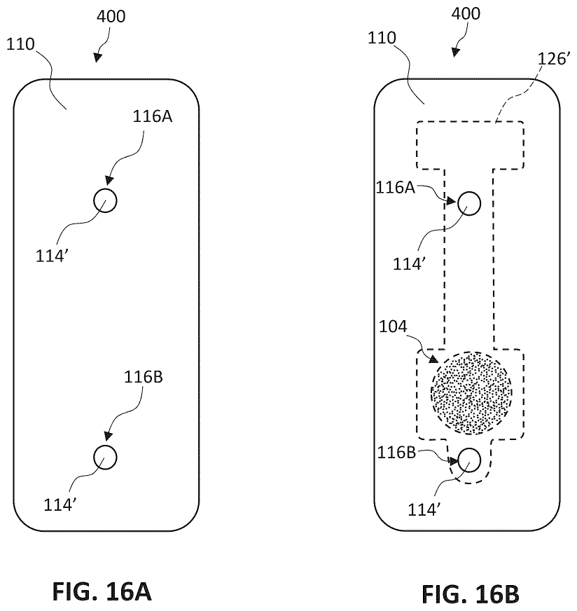

FIGS. 16-18 illustrate another example embodiment of an environmental indicator 400. As shown, the indicator can have a form that is similar to the form of other embodiments described herein, e.g., in FIGS. 1 and 7-15. As an example, the environmental indicator 400 can include a substrate (e.g., substrate 102 shown in FIG. 1), microcapsules 104 containing environmental indicator material 106 and/or activation marker material 109, a wick 114′, overlaminate film (e.g., overlaminate film 108 shown in FIG. 1), and the top viewing layer 110. The wick 114′ can be disposed on or embedded in the substrate and the microcapsules 104 can be deposit on, under, or proximate to the wick 114′. The wick 114′ can be identical to the wick 114 except that a perimeter 126′ of the wick 114′ differs from the perimeter 126. The perimeter 126′ of the wick 114′ can be sealed, e.g., with an adhesive. As an example, the overlaminate film can be adhered to the substrate along the perimeter 126 of the wick 114′. The top viewing layer 110 can be generally opaque such that the contents of the indicator that are under the top viewing layer 110 cannot be readily visible. The top viewing layer 110 can provide a printable surface upon which indicia (e.g., alphanumeric characters and/or symbologies) can be printed. The top viewing layer 110 can also include the viewing windows 116 (e.g., viewing windows 116A and 116B). As an example, the viewing windows 116 can allow for viewing of portions of the wick 114′ (e.g., through the overlaminate film) and can be used to determine whether the environmental indicator 400 is in the non-activated configuration, the activated configuration (e.g., in response to an activation event) and/or whether the environmental indicator material has been exposed to a predetermined environmental stimulus after environmental indicator material has been placed in the activated configuration (i.e., the exposed configuration). The environmental indicator 400 can be determined to be in the non-activated configuration via a visual indicator that is observable via the viewing windows 116 (e.g., the wick 114 is viewable and devoid of the environmental indicator material).

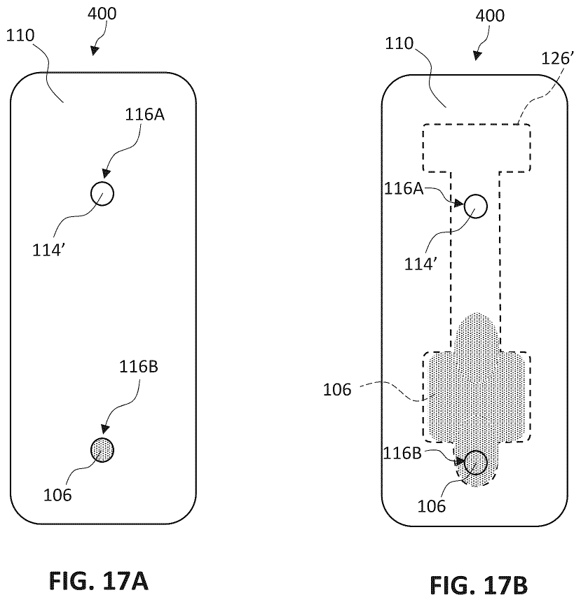

The perimeter 126′ of the wick 114′ can include a portion that extends, at the first end of the wick 114′, away from the area where the microcapsules 104 are disposed and in a direction that away from the second end of the wick 114′. The viewing area 116B can be disposed to align with the portion of the wick 114′ at the first end of the wick 114′ and the viewing window 116A can be disposed proximate to a second end of the wick 114′ such that the microcapsules are disposed between the viewing window 116A and the viewing window 116B. As shown in FIG. 17A-B, after an activation event causes the environmental indicator material 106 to be released from the microcapsules 104 and before the released environmental indicator material 106 is exposed to the predetermined environmental stimulus, a portion of the released environmental indicator material 106 can be forced, by the activation event, to migrate along the wick 114′ such that a portion of the environmental indicator material 106 is viewable via the viewing window 116B. As an example, when the activation event corresponds to applying pressure to the microcapsules 104, when the microcapsules burst or rupture, the pressure applied to the area including the microcapsules 104 can squeeze the environmental indicator material 106 and push it to other portions of the wick 114′. When the environmental indicator material 106 is forced along the wick 114 towards the first end of the wick 114′ in response to the activation event and is viewable via the viewing window 116B, the observability of the environment indicator material 106 via the viewing window 116B provides a visual indication that the environmental indicator has been placed in the activated configuration, while the absence of the environmental indicator material 106 for the portion of the wick 114′ viewable via the viewing window 116A can indicate that the released environmental indicator material 106 has not been exposed to the predetermined environmental stimulus. In some examples, the presence of the environmental indicator material in the viewing window 116B and the absence of the environmental indicator material in the viewing window 116A can be a visual indication that the environmental indicator is in the activated configuration.

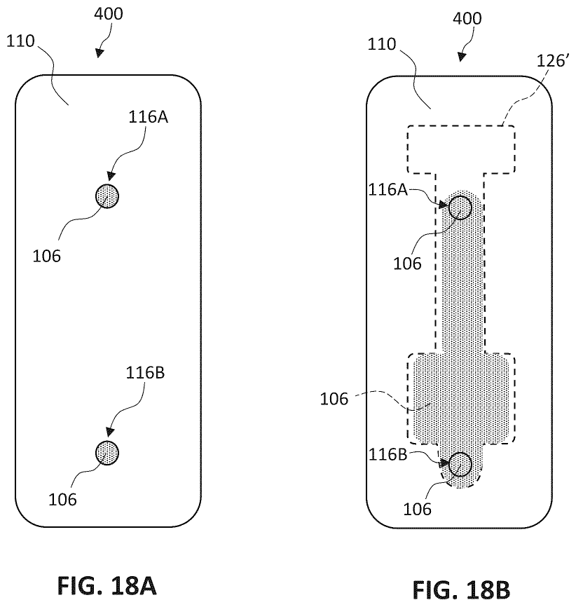

FIGS. 18A-B illustrate a state of the environmental indicator 400 in an activated configuration after an activation event causing the environmental indicator material 106 to be released from the microcapsules 104 and after the released environmental indicator material 106 is exposed to the predetermined environmental stimulus. As shown in FIGS. 15A-B, the environmental indicator material has diffused along the wick 114′ towards a second end of the wick 114′ such that the environmental indicator material 106 is viewable on the portion of the wick 114′ that is viewable via the viewing window 116A which can indicate that the released environmental indicator material 106 has been exposed to the predetermined environmental stimulus. The presence of the environmental indicator material in the viewing windows 116A and 116B can be a visual indication that the environmental indicator is in the exposed configuration.

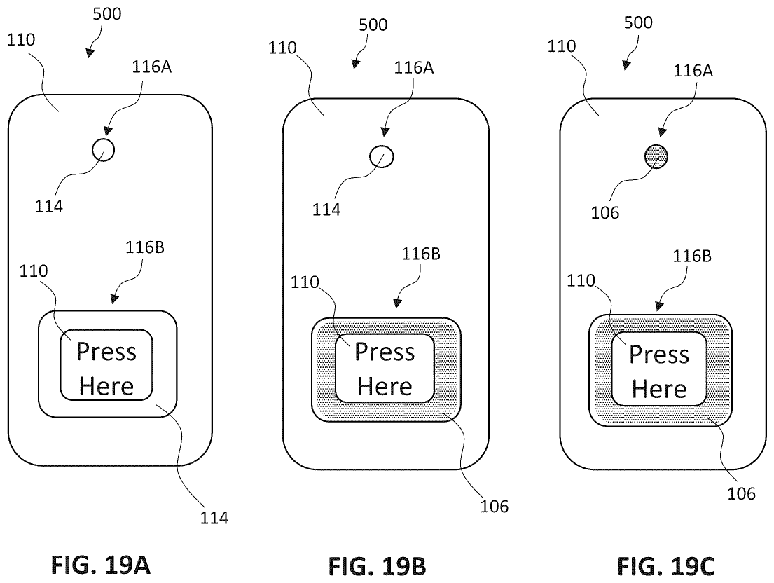

FIGS. 19A-C illustrate another example embodiment of an environmental indicator 500. FIG. 19A shows the environmental indicator 500 in the non-activated configuration. FIG. 19B shows the environmental indicator 500 after the environmental indicated is placed in the activated configuration and before the released environmental indicator material 106 is exposed to the predetermined environmental stimulus. FIG. 19C shows the environmental indicator 500 after the environmental indicator 500 is placed in the activated configuration and after the released environmental indicator material 106 is exposed to the predetermined environmental stimulus. The environmental indicator 500 can have an identical structure as the environmental indicator 300 illustrated in FIGS. 13-15 except that the viewing window 116B is defined as a ring that encircles an opaque portion 110A of the top viewing layer 110. The opaque portion 110A surrounded by the viewing window 116B and the viewing window 116B itself can be positioned over the first end of the wick 114, while the viewing window 116A can be disposed proximate to the second end of the wick 114′. The opaque portion 110A surrounded by the viewing window 116B can be disposed over the microcapsules 104. In some embodiments, the opaque portion 110A can include one or more symbols, text, or other information. For example, in the present example, the opaque portion 110A can include instructional language (e.g., “Press Me”) for placing the environmental indicator in the activated configuration.

In the non-activated configuration, the wick 114 visible via the viewing windows 116A-B is devoid of the environmental indicator material which can provide a visual indication that the environmental indicator 500 is in the non-activated configuration. In response to an activation event, e.g., the opaque portion has been pressed, the microcapsules can release the environmental indicator material 106 which can be forced, by the activation event, in one or more directions on the wick 114 such that environment indicator material 106 can be viewable on the portion of the wick 114 that is viewable via the viewing window 116B, which can provide a visual indication that the environmental indicator is in the activated configuration. While the environmental indicator material 106 has not been exposed to the predetermined environmental stimulus, the environmental indicator 500 does not diffuse along the wick 114 and the environment indicator material is not viewable via the viewing window 116A, as shown in FIG. 19B. In some examples, the presence of the environmental indicator material in the viewing window 116B and the absence of the environmental indicator material in the viewing window 116A can be a visual indication that the environmental indicator is in the activated configuration. When the released environment indicator material 106 is exposed to the predetermined environment stimulus, the environmental indicator material can diffuse along the wick 114 from the first end towards the second end of the wick 114 such that the environmental indicator material 106 is viewable on the portion of the wick 114 that is viewable via the viewing window 116A which can be a visual indication that the released environmental indicator material 106 has been exposed to the predetermined environmental stimulus (i.e., is in the exposed configuration). The presence of the environmental indicator material in the viewing windows 116A and 116B can be a visual indication that the environmental indicator is in the exposed configuration.

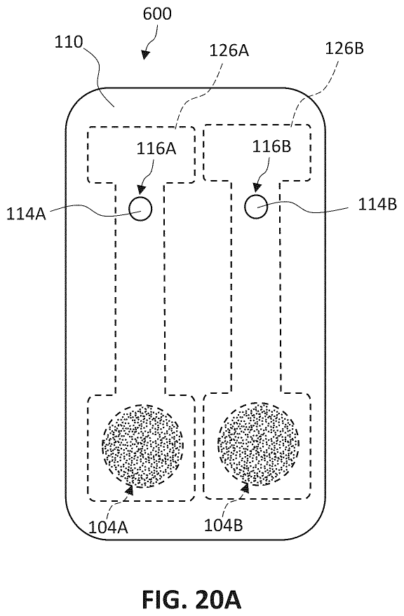

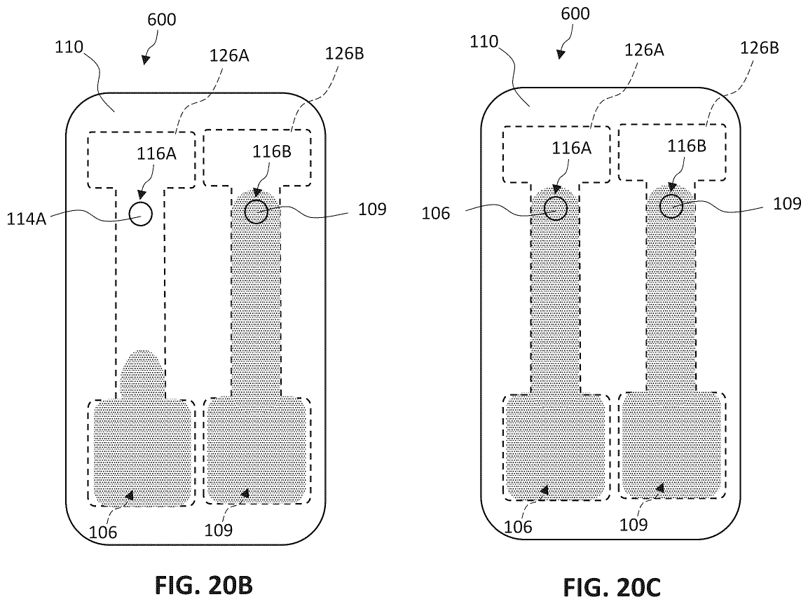

FIGS. 20A-C illustrate another example embodiment of an environmental indicator 600. FIG. 20A shows the environmental indicator 600 in the non-activated configuration. FIG. 20B shows the environmental indicator 600 after the environmental indicated is placed in the activated configuration and before the released environmental indicator material 106 is exposed to the predetermined environmental stimulus. FIG. 20C shows the environmental indicator 600 after the environmental indicated is placed in the activated configuration and after the released environmental indicator material 106 is exposed to the predetermined environmental stimulus.

As shown in FIGS. 20A-C, the environmental indicator 600 can have a form that is similar to the form of other embodiments described herein, e.g., in FIGS. 1 and 7-19 except that the environmental indicator 600 can include two separate wicks 114A and 114B. As an example, the environmental indicator 600 can include a substrate (e.g., substrate 102 shown in FIG. 1), microcapsules 104A containing environmental indicator material 106, microcapsules 104B containing activation marker material 109, the wicks 114A-B, overlaminate film (e.g., overlaminate film 108 shown in FIG. 1), and the top viewing layer 110. The wicks 114A-B can be disposed on or embedded in the substrate and the microcapsules 104A-B can be deposited on, under, or proximate to first ends of the wicks 114A-B, respectively. A perimeter of the wicks 114A-B can be scaled, e.g., with an adhesive. As an example, the overlaminate film can be adhered to the substrate along the perimeters of the wicks 114A-B. The top viewing layer 110 can be generally opaque such that the contents of the environmental indicator 600 that are under the top viewing layer 110 cannot be readily visible. The top viewing layer 110 can provide a printable surface upon which indicia (e.g., alphanumeric characters and/or barcode symbologies) can be printed. The top viewing layer 110 can also include the viewing windows 116 (e.g., viewing window 116A and 116B). As an example, the viewing window 116A can allow for viewing of portions of the wick 114A (e.g., through the overlaminate film) and the viewing window 116B can allow for viewing of portions of the wick 114B (e.g., through the overlaminate film). The viewing window 116B can be used to determine whether the environmental indicator 600 is in the activated configuration (e.g., in response to an activation event) and the viewing window 116A can be used to determine whether the environmental indicator material 106 has been exposed to a predetermined environmental stimulus after environmental indicator 600 has been placed in the activated configuration. The viewing window 116A can be disposed proximate to a second end of the wick 114A and the viewing window 116B can be disposed proximate to a second end of the wick 114B. In the non-activated configuration, the wicks 114A-B visible via the viewing windows 116A-B, respectively, are devoid of the environmental indicator material which can provide a visual indication that the environmental indicator 600 is in the non-activated configuration.

As shown in FIG. 20B, in response to the activation event, the environmental indicator material 106 can be released from the microcapsules 104A and the activation marker material 109 can be released from the microcapsules 104B. After the activation event and before the released environmental indicator material 106 is exposed to the predetermined environmental stimulus, the environmental indicator material 106 can remain generally near the first end of the wick 114A and does not diffuse along the wick 114A to the second end of the wick 114A such that the environmental indicator material is not viewable via the viewing window 116A. In contrast, still referring to FIG. 20B, after the activation and before exposure to the predetermined environmental stimulus, the activation marker material 109 diffuses along the wick 114B towards the second end of the wick 114B such that the activation marker material 109 is viewable via the viewing window 116B which can provide a visual indication that the environmental indicator 600 has been placed in the activated configuration. In some examples, the presence of the activation marker material in the viewing window 116B and the absence of the environmental indicator material in the viewing window 116A can be a visual indication that the environmental indicator is in the activated configuration.

As shown in FIG. 20C, when the released environment indicator material 106 is exposed to the predetermined environment stimulus, the environmental indicator material 106 can diffuse along the wick 114A from the first end towards the second end of the wick 114A such that the environmental indicator material 106 is viewable on the portion of the wick 114A that is viewable via the viewing window 116A which can be a visual indication that the environmental indicator has been exposed to the predetermined environmental stimulus. The presence of the environmental indicator material in the viewing window 116A and the presence of the activation marker material in the viewing window 116B can be a visual indication that the environmental indicator is in the exposed configuration.

### Activation Methods

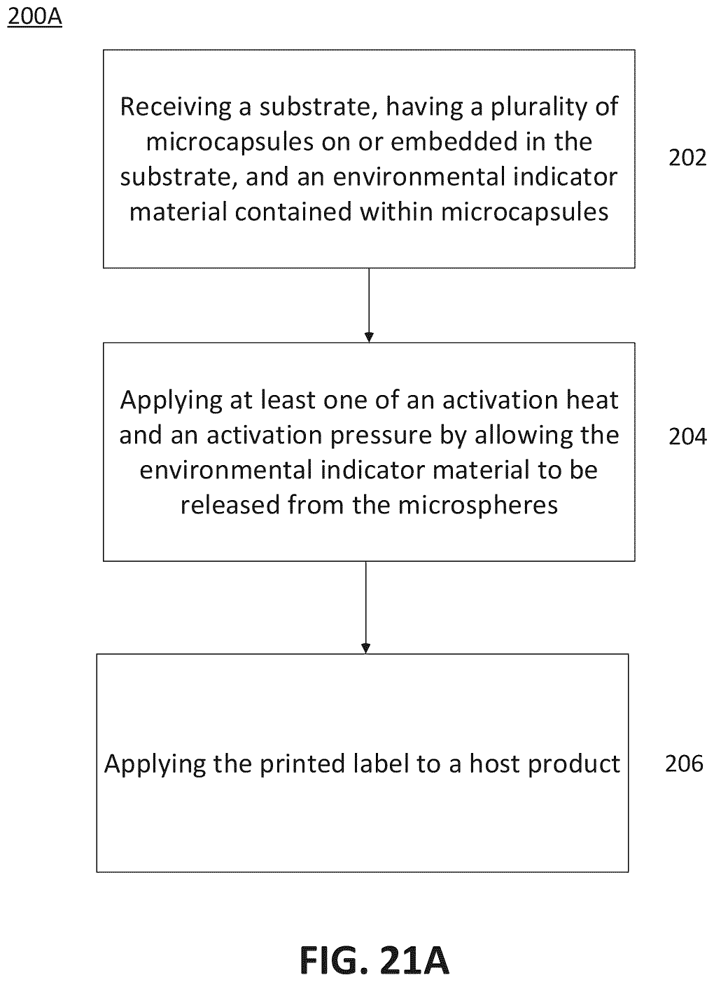

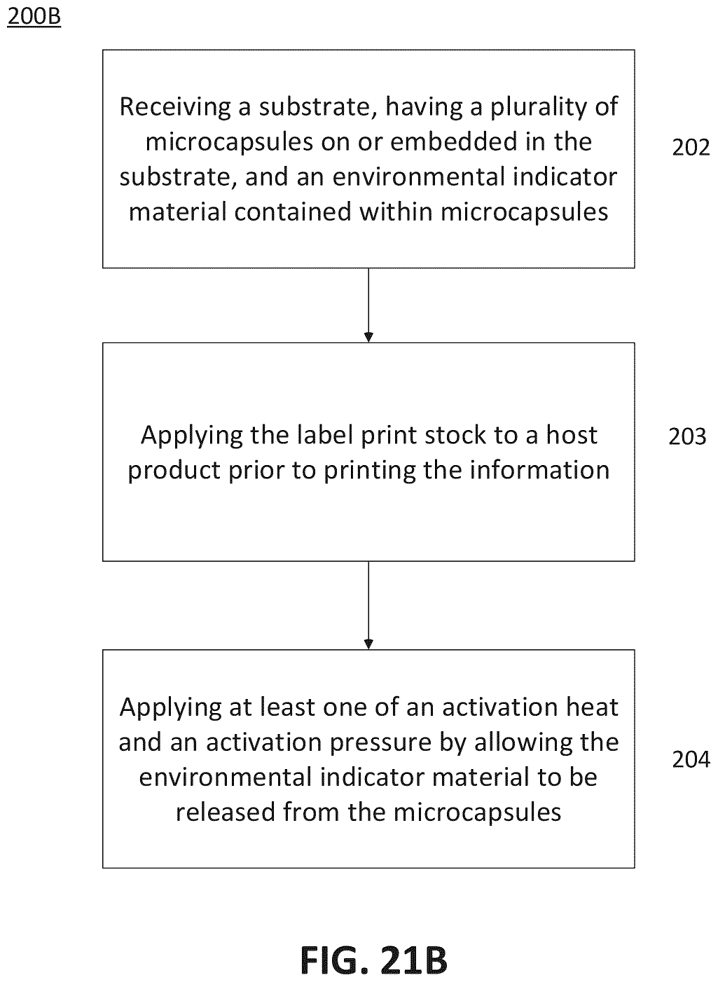

An example procedure 200A for activating an activatable environmental sensor print medium (e.g., the activatable environmental indicators 100, 300, 400, 500, and 600) is disclosed herein and shown in FIG. 21A. In 202, a substrate (e.g., the substrate 102) having microcapsules (e.g., the microcapsules 104) on or embedded in the substrate and an environmental indicator material (e.g., the environmental indicator material 106) contained within the microcapsules is received. For example, this may be any of the examples described previously in the present disclosure, e.g., the examples shown in FIGS. 7-20. In 204, while the indicator is printed, an activation heat and/or an activation pressure is applied which ruptures the microcapsules, allowing the environmental indicator material 106 and/or activation marker material 109 to be released from the microcapsules. Upon release from the microcapsules 104, the environmental indicator material 106 is configured to respond to exposure to a predetermined environmental stimulus by causing a detectable response. In some embodiments, in 206 the printed label may be applied to a host product or its package, e.g., using an adhesive on the label or a separately applied adhesive.

An alternative example procedure 200B for activation is shown in FIG. 21B. In 202, a substrate (e.g., the substrate 102) having microcapsules (e.g., the microcapsules 104) on or embedded in the substrate and an environmental indicator material (e.g., the environmental indicator material 106) contained within the microcapsules is received. The substrate may be printed without activating the indicator, e.g., by printing at a lower temperature and/or with less pressure than is required to materially affect the microspheres. Optionally, in 203, the printed substrate may be applied to a host product or to a package without activation of the microcapsules. At a later time, at least one of an activation heat and/or an activation pressure, which is greater than the printing temperature and/or pressure is applied which ruptures the microspheres and allows the environmental indicator material and/or activation marker material to be released from the microcapsules. This may be accomplished, for example, using the same printer device as was used for printing but with a different temperature setting, or may be accomplished using a different device.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. Additionally, the described embodiments/examples/implementations should not be interpreted as mutually exclusive, and should instead be understood as potentially combinable if such combinations are permissive in any way. In other words, any feature disclosed in any of the aforementioned embodiments/examples/implementations may be included in any of the other aforementioned embodiments/examples/implementations.

The benefits, advantages, solutions to problems, and any element(s) that may cause any benefit, advantage, or solution to occur or become more pronounced are not to be construed as a critical, required, or essential features or elements of any or all the claims. The claimed invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter may lie in less than all features of a single disclosed embodiment. Thus, the following claims are hereby incorporated into the Detailed Description, with each claim standing on its own as a separately claimed subject matter.

1. An activatable environmental indicator, comprising:
a substrate, and
a plurality of microcapsules supported by the substrate,
the activatable environmental indicator having a non-activated configuration that is unresponsive to a predetermined environmental stimulus, an activated configuration that is responsive to the predetermined environmental stimulus, and an exposed configuration after responding to the predetermined environmental stimulus;
at least a subset of the plurality of microcapsules release an environmental indicator material in response to an activation event that transitions the activatable environmental indicator from the non-activated configuration to the activated configuration,
the activatable environmental indicator is responsive to the predetermined environmental stimulus after the activation event and transitions from the activated configuration to the exposed configuration in response to exposure to the predetermined environmental stimulus, and
the activatable environmental indicator includes a first visual indicator when the activatable indicator is in the non-activated configuration, a second visual indicator when the activatable indicator is in the activated configuration, and a third visual indicator when the activatable indicator is in the exposed configuration.

2. The activatable environmental indicator of claim 1, further comprising:
a wick supported by the substrate, the plurality of microcapsules disposed proximate to a first end of the wick; and
an opaque top viewing layer covering the wick and the plurality of microcapsules, the opaque top viewing layer includes a plurality of viewing windows disposed over and aligned with the wick such that portions of the wick are viewable via the plurality viewing windows,
the environmental indicator material is forced along a portion of the wick in response to the activation event such that the environmental indicator material is visible via a first viewing window of the plurality of viewing windows and is not visible via a second viewing window of the plurality of viewing windows.

3. The activatable environmental indicator of claim 2, wherein, after the activation event, the environmental indicator material diffuses along the wick in response to exposure to the predetermined environmental stimulus such that the environmental indicator material is visible via the first viewing window and the second viewing window when the environmental indicator is in the exposed configuration.

4. The activatable environmental indicator of claim 3, wherein the first visual indicator corresponds to the wick being viewable via the first and second viewing windows and being devoid of the environmental indicator material.

5. The activatable environmental indicator of claim 3, wherein the second visual indicator corresponds to the environmental indicator material being viewable via the first viewing window and the wick devoid of the environmental indicator material being viewable via the second viewing window.

6. The activatable environmental indicator of claim 3, wherein the third visual indicator corresponds the environmental indicator being viewable via the first and second viewing windows.

7. The activatable environmental indicator of claim 1, wherein at least the subset of the plurality of microcapsules or a different subset of the plurality of microcapsules release an activation marker material in response to the activation event.

8. The activatable environmental indicator of claim 7, wherein visibility of the activation marker material corresponds to the second visual indicator and visibility of the environmental indicator material corresponds to the third visual indicator.

9. The activatable environment indicator of claim 8, wherein the activation marker material has a first color and the environmental indicator material has a second color.

10. The activatable environmental indicator of claim 7, further comprising:
a wick supported by the substrate, the plurality of microcapsules disposed proximate to a first end of the wick; and
an opaque top viewing layer covering the wick and the plurality of microcapsules, the opaque top viewing layer includes a viewing window disposed over and aligned with the wick such that a portion of the wick is viewable via the viewing window,
wherein, in response to the activation event, the activation marker material diffuses along the wick such that the activation marker material is viewable via the viewing window and the environmental indicator material is not visible via the viewing window.

11. The activatable environmental indicator of claim 10, wherein, after the activation event and in response to exposure to the predetermined environmental stimulus, the environmental indicator material diffuses along the wick such that the environmental indicator is viewable view the viewing window.

12. The activatable environmental indicator of claim 10, wherein the viewing window is disposed proximate a second end of the wick and the activation marker material diffuses along the wick towards the second end of the wick, and
wherein, after the activation event, absent exposure to the predetermined environmental stimulus, the environmental indicator material remains proximate a first end of the wick.

13. The activatable environmental indicator of claim 1, further comprising:
a first wick supported by the substrate, the subset of the plurality of microcapsules disposed proximate to the first wick;
a second wick supported by the substrate, a different subset of the plurality of microcapsules disposed proximate to the second wick, the different subset of the plurality of microcapsules containing an activation marker material; and
an opaque top viewing layer covering the first wick, the second wick, the subset of the plurality of microcapsules, and the different subset of the plurality of microcapsules, the opaque top viewing layer includes a first viewing window and a second viewing window, the first viewing window disposed over and aligned with a first portion of the first wick such that the first portion of the first wick is viewable via the first viewing window, the second viewing window disposed over and aligned with a second portion of the second wick such that the second portion of the second wick is viewable via the second viewing window,
wherein, in response to the activation event, the activation marker material migrates along the second wick such that the activation marker material is viewable via the second viewing window and the environmental indicator material does not migrate along the first wick such that the environment indicator material is not viewable via the first viewing window.

14. The activatable environmental indicator of claim 13, wherein, after the activation event and in response to exposure to the predetermined environmental stimulus, the environmental indicator material migrates along the first wick such that the environmental indicator is viewable view the first viewing window.

15. (canceled)

16. The activatable environmental indicator of claim 1, wherein the environmental indicator material comprises a meltable solid configured to melt into a liquid in response to exposure to the predetermined environmental stimulus.

17. (canceled)

18. (canceled)

19. The activatable environmental indicator of claim 1, wherein the environmental indicator material comprises a gel configured to, in response to a predetermined temperature above a threshold, change viscosity causing the gel to migrate along the substrate for at least a predetermined distance when remaining at a temperature above the threshold for at least a predetermined time period, and
wherein the environmental indicator material further includes a colorant that migrates together with the gel.

20. The activatable environmental indicator of claim 1, wherein the plurality of microcapsules are configured to release the environmental indicator material in response to at least one of an activation heat or an activation pressure provided by a thermal print head.

21. (canceled)

22. (canceled)

23. (canceled)

24. (canceled)

25. (canceled)

26. (canceled)

27. A method, comprising:
rendering, by an activatable environmental indicator, a first visual indicator that indicates that the activatable environmental indicator is in a non-activated configuration;
transitioning the activatable environmental indicator from the non-activated configuration to an activated configuration in response to an activation event, the activatable environmental indicator including a substrate and a plurality of microcapsules supported by or embedded in the substrate, at least a subset of the plurality of microcapsules containing an environmental indicator material, the at least a subset of the plurality of microcapsules releasing the environmental indicator material in response to the activation event;
rendering, by the activatable environmental indicator, a second visual indicator that indicates the activatable environmental indicator is in the activated configuration;
transitioning the activatable environmental indicator from the activated configuration to an exposed configuration in response to exposing the activatable environmental indicator to a predetermined environmental stimulus; and
rendering, by the activatable environmental indicator, a third visual indicator that indicates the activatable environmental indicator is in the exposed configuration.

28. The method of claim 27, wherein the activatable environmental indicator includes a wick supported by the substrate, the plurality of microcapsules disposed proximate to a first end of the wick and an opaque top viewing layer covering the wick and the plurality of microcapsules, the opaque top viewing layer includes a plurality of viewing windows disposed over and aligned with the wick such that portions of the wick are viewable via the plurality viewing windows, and the method further comprises:
disbursing the environmental indicator material along a portion of the wick in response to a force generated by the activation event such that the environmental indicator material is visible via a first viewing window of the plurality of viewing windows and is not visible via a second viewing window of the plurality of viewing windows.

29. (canceled)

30. (canceled)

31. The method of claim 27, wherein the activatable environmental indicator includes a wick supported by the substrate and an opaque top viewing layer covering the wick and the plurality of microcapsules, the opaque top viewing layer includes a viewing window disposed over and aligned with a portion of the wick such that the portion of the wick is viewable via the viewing window, the plurality of microcapsules disposed proximate to the wick, at least the at least a subset of the plurality of microcapsules or a different subset of the plurality of microcapsule containing an activation marker material, and the method further comprising:
in response to the activation event, migrating the activation marker material along the wick such that the activation marker material is viewable via the viewing window and the environmental indicator material is not viewable via the viewing window.

32. (canceled)

33. (canceled)

34. (canceled)

35. (canceled)

36. (canceled)
